(19) United States
(12) Patent Application Publication
(10) Pub. No.: US 2015/0062057 A1
(43) Pub. Date: Mar. 5, 2015

(54) Method and Apparatus for Apparatus Input

(71) Applicant: Nokia Corporation, Espoo (FI)

(72) Inventors: Shahil Soni, Espoo (FI); Timo-Pekka Olavi Viljamaa, Helsinki (FI); Martin Jansky, Espoo (FI)

(21) Appl. No.: 14/015,906

(22) Filed: Aug. 30, 2013

(51) Int. Cl. G06F 3/041

(52) U.S. Cl. CPC G06F 3/0414
USPC 345/174

(57) ABSTRACT

A method comprising receiving an indication of a first touch input that is associated with a region of a grip surface of an apparatus, the first touch input comprising a contact input, determining that the first touch input is a setting designation input that designates a setting for adjustment, receiving an indication of a second touch input that is associated with a different region of a grip surface of the apparatus, the second touch input being separate from the first touch input, performing adjustment of a value of the setting based, at least in part, on the second touch input, and receiving an indication of a release input of the first touch input is disclosed.

### TECHNICAL FIELD

The present application relates generally to apparatus input.

### BACKGROUND

Electronic apparatuses, such as mobile communication apparatuses, are becoming more and more versatile. Apparatuses can perform numerous functions and a user can provide inputs that will cause an apparatus to take desired actions or change its behavior based on the inputs. It may be desirable for user input associated with an apparatus to be convenient for the user. It may also be desirable to design the apparatus so that the apparatus does what the user wants it to do in response to input from the user.

### SUMMARY

Various aspects of examples of the invention are set out in the claims.

One or more embodiments may provide an apparatus, a computer readable medium, a non-transitory computer readable medium, a computer program product, and a method for receiving an indication of a first touch input that is associated with a region of a grip surface of an apparatus, the first touch input comprising a contact input, determining that the first touch input is a setting designation input that designates a setting for adjustment, receiving an indication of a second touch input that is associated with a different region of a grip surface of the apparatus, the second touch input being separate from the first touch input, performing adjustment of a value of the setting based, at least in part, on the second touch input, and receiving an indication of a release input of the first touch input.

One or more embodiments may provide an apparatus, a computer readable medium, a computer program product, and a non-transitory computer readable medium having means for receiving an indication of a first touch input that is associated with a region of a grip surface of an apparatus, the first touch input comprising a contact input, means for determining that the first touch input is a setting designation input that designates a setting for adjustment, means for receiving an indication of a second touch input that is associated with a different region of a grip surface of the apparatus, the second touch input being separate from the first touch input, means for performing adjustment of a value of the setting based, at least in part, on the second touch input, and means for receiving an indication of a release input of the first touch input.

In at least one example embodiment, performance of adjustment of the value of the setting is predicated by continued contact of the first touch input during receipt of the second touch input.

In at least one example embodiment, determination that the first touch input is a setting designation input is predicated by the first touch input being associated with the region of the grip surface.

One or more example embodiments further perform determination that the first touch input is associated with the region of the grip surface, wherein determination that the first touch input is a setting designation input is predicated by the first touch input being associated with the region of the grip surface.

In at least one example embodiment, the grip surface relates to a surface of the apparatus configured to be held by a user.

In at least one example embodiment, configuration to be held by a user relates to an edge of the apparatus.

In at least one example embodiment, the grip surface relates to a back surface of the apparatus.

In at least one example embodiment, the back surface relates to a surface of the apparatus opposite to a surface associated with a primary display.

In at least one example embodiment, the determination that the first touch input is a setting designation input that designates a setting for adjustment is based, at least in part, on a determination that the contact input of the first touch input exceeds a threshold force.

In at least one example embodiment, the determination that the contact input of the first touch input exceeds a threshold force is based, at least in part, on force sensor information.

In at least one example embodiment, the grip surface of the first touch input is the same as the grip surface of the second touch input.

In at least one example embodiment, the grip surface of the first touch input is different from the grip surface of the second touch input.

One or more example embodiments further perform determination that the second touch input corresponds with at least one predetermined grip region associated with adjustment of the setting, wherein performance of adjustment of the value of the setting is predicated by the determination that the second touch input corresponds with at least one predetermined grip region associated with adjustment of the setting.

In at least one example embodiment, determination that the second touch input corresponds with at least one predetermined grip region associated with adjustment of the setting comprises determination that the different region of the grip surface corresponds with at least one predetermined grip region associated with adjustment of the setting.

In at least one example embodiment, the second touch input relates to a tap input and performance of the adjustment of the value of the setting is by way of at least one of a decrement of the value of the setting by a predetermined value, or an increment of the value of the setting by a predetermined value.

One or more example embodiments further perform determination to perform the increment based, at least in part, on the different region of the grip surface being associated with an increment adjustment.

In at least one example embodiment, the grip surface relates to a top edge of the apparatus.

In at least one example embodiment, the grip surface relates to a right edge of the apparatus.

One or more example embodiments further perform determination to perform the decrement based, at least in part, on the different region of the grip surface being associated with a decrement adjustment.

In at least one example embodiment, the grip surface relates to a bottom edge of the apparatus.

In at least one example embodiment, the grip surface relates to a left edge of the apparatus.

In at least one example embodiment, the second touch input comprises a contact input and a release input at a position that corresponds with a region of an edge of the apparatus, and performance of the adjustment of the value of the setting is by way of an increment of the value of the setting by a predetermined value.

One or more example embodiments further perform determination that a threshold duration has elapsed since performance of the adjustment absent receipt of the release input of the second touch input, and performance of another adjustment of the value of the setting by way of an increment of the value of the setting by the predetermined value based, at least in part, on the determination that the threshold duration has elapsed since performance of the adjustment absent receipt of the release input of the second touch input.

One or more example embodiments further perform receipt of an indication of a third touch input that comprises a contact input and a release input at a position that corresponds with a region of an opposite edge of the apparatus from the edge of the apparatus of the second touch input, and performance of another adjustment of the value of the setting by way of a decrement of the value of the setting by the predetermined value.

One or more example embodiments further perform determination that a threshold duration has elapsed since performance of the other adjustment absent receipt of the release input of the third touch input, and performance of another different adjustment of the value of the setting by way of another decrement of the value of the setting by the predetermined value based, at least in part, on the determination that the threshold duration has elapsed since performance of the other adjustment absent receipt of the release input of the third touch input.

In at least one example embodiment, the second touch input comprises a contact input, a movement input, and a release input, wherein the performance of the adjustment of the value of the setting based, at least in part, on the movement input.

In at least one example embodiment, the performance of the adjustment comprises either of an increase of the value of the setting, or a decrease in the value of the setting based, at least in part on a direction of the movement input.

In at least one example embodiment, a magnitude of the adjustment of the value of the setting is based, at least in part, on a distance of the movement input.

In at least one example embodiment, the second touch input relates to a drag input.

One or more example embodiments further perform determination that the second touch input relates to a drag input, wherein causation of the magnitude of the adjustment of the value setting being based, at least in part, on the distance of the movement is based, at least in part on the determination that the second touch input relates to a drag input.

In at least one example embodiment, a magnitude of the adjustment of the value of the setting is based, at least in part, on a speed of the movement input.

In at least one example embodiment, the second touch input relates to a flick input.

One or more example embodiments further perform determination that the second touch input relates to a flick input, wherein causation of the magnitude of the adjustment of the value setting being based, at least in part, on the speed of the movement is based, at least in part on the determination that the second touch input relates to the flick input.

One or more example embodiments further perform causation of display of a setting indicator that identifies the setting.

In at least one example embodiment, causation of display of the setting indicator is caused by the determination that the first touch input is a setting designation input that designates a setting for adjustment.

One or more example embodiments further perform causation of termination of display of the setting indicator based, at least in part, on receipt of the release input of the first touch input.

One or more example embodiments further perform causation of display of a plurality of indicators of adjustable settings.

One or more example embodiments further perform causation of display of a setting indicator that identifies one of the indicators of the plurality of indicators of adjustable settings as the setting.

In at least one example embodiment, causation of display of the setting indicator is caused by the determination that the first touch input is a setting designation input that designates a setting for adjustment.

One or more example embodiments further perform causation of termination of display of the setting indicator based, at least in part, on receipt of the release input of the first touch input.

In at least one example embodiment, causation of display of the plurality of indicators of adjustable settings is caused by the determination that the first touch input is a setting designation input that designates a setting for adjustment.

One or more example embodiments further perform causation of termination of display of the indicators of the plurality of adjustable settings based, at least in part, on receipt of the release input of the first touch input.

One or more example embodiments further perform causing display of an indication of the value of the setting.

In at least one example embodiment, the indication of the value of the setting relates to a graphical representation of the value.

In at least one example embodiment, the graphical representation of the value relates to graphical representation that indicates the value as a position along a line.

In at least one example embodiment, the indication of the value of the setting relates to a textual representation of the value.

In at least one example embodiment, the textual representation of the value is positioned proximate to a setting indicator that identifier the setting.

In at least one example embodiment, causation of display of the indication of the value of the setting is caused by receipt of the first touch input.

In at least one example embodiment, causation of display of the indication of the value of the setting is caused by receipt of the second touch input.

One or more example embodiments further perform causation of termination of display of the indication of the value of the setting.

In at least one example embodiment, termination of display of the indication of the value of the setting is caused by the receipt of the release input of the first touch input.

In at least one example embodiment, termination of display of the indication of the value of the setting is caused by receipt of a release input of the second touch input.

In at least one example embodiment, the first touch input and second touch input are absent motion of the apparatus.

In at least one example embodiment, the first touch input and the second touch input are absent a touch input at a position on a touch display.

In at least one example embodiment, determination that the first touch input is a setting designation input that designates the setting for adjustment is based, at least in part, on position of the first touch input.

In at least one example embodiment, determination that the first touch input is a setting designation input that designates the setting for adjustment is based, at least in part, on correlation of a position of the first touch input and a position associated with at least one textural indicator.

In at least one example embodiment, determination that the first touch input is a setting designation input that designates the setting for adjustment is based, at least in part, on alignment of a position of the first touch input and a setting indicator that identifies the setting along a common axis.

In at least one example embodiment, the common axis relates to a vertical axis.

In at least one example embodiment, the common axis relates to a horizontal axis.

In at least one example embodiment, the setting relates to a camera setting.

In at least one example embodiment, the first touch input is received during operation of a viewfinder of an image capture program.

In at least one example embodiment, the setting relates to performance of an operation.

One or more example embodiment further performs the operation in conformance with the value of the setting.

One or more example embodiment further performs the operation in conformance with the value of the setting based, at least in part, on receipt of a third touch input.

One or more example embodiment further performs the operation in conformance with the value of the setting based, at least in part, on receipt of the release input of the first touch input.

In at least one example embodiment, the release input of the first touch input causes performance of the operation in conformance with the value of the setting.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to an example embodiment;

FIGS. 2A-2D are diagrams illustrating grip surfaces according to at least one example embodiment;

FIGS. 3A-3E are diagrams illustrating touch inputs according to at least one example embodiment;

FIGS. 4A-4D are diagrams illustrating regions of a grip surface according to at least one example embodiment;

FIGS. 5A-5C are diagrams illustrating indications of region indications according to at least one example embodiment;

FIGS. 6A-6D are diagrams illustrating information displayed in association with adjustment of a value of a setting according to at least one example embodiment;

FIG. 7 is a flow diagram illustrating activities associated with adjustment of a value of a setting according to at least one example embodiment;

FIG. 8 is a flow diagram illustrating activities associated with adjustment of a value of a setting according to at least one example embodiment;

FIG. 9 is a flow diagram illustrating activities associated with adjustment of a value of a setting according to at least one example embodiment;

FIG. 10 is a flow diagram illustrating activities associated with adjustment of a value of a setting according to at least one example embodiment;

FIG. 11 is a flow diagram illustrating activities associated with adjustment of a value of a setting according to at least one example embodiment;

FIG. 12 is a flow diagram illustrating activities associated with adjustment of a value of a setting according to at least one example embodiment;

FIG. 13 is a flow diagram illustrating activities associated with adjustment of a value of a setting according to at least one example embodiment; and

FIG. 14 is a flow diagram illustrating activities associated with adjustment of a value of a setting according to at least one example embodiment.

### DETAILED DESCRIPTION OF THE DRAWINGS

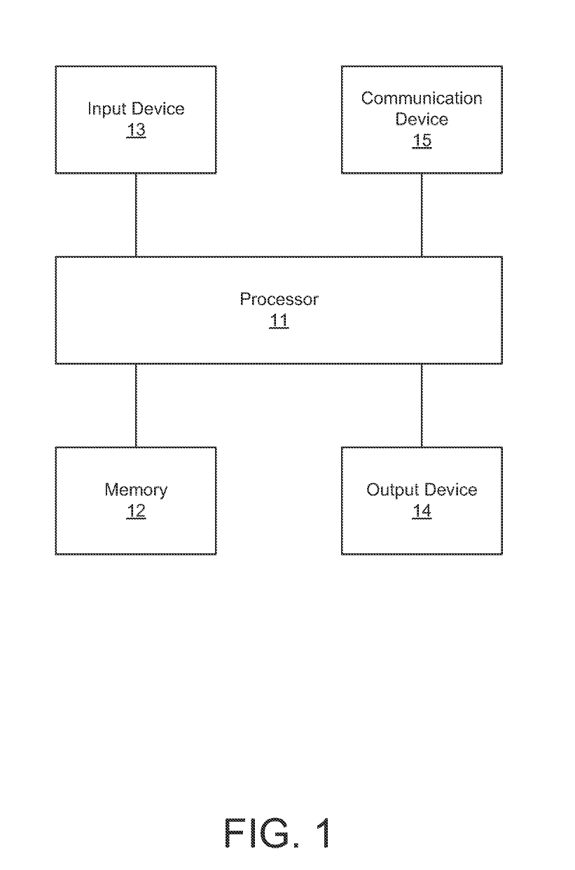

An embodiment of the invention and its potential advantages are understood by referring to FIGS. 1 through 14 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a portable digital assistant (PDAs), a pager, a mobile computer, a desktop computer, a television, a gaming apparatus, a laptop computer, a media player, a camera, a video recorder, a mobile phone, a global positioning system (GPS) apparatus, and/or any other types of electronic systems. Moreover, the apparatus of at least one example embodiment need not be the entire electronic apparatus, but may be a component or group of components of the electronic apparatus in other example embodiments.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output Device 14 may comprise a visual output device, such as a display, a light, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives information indicative of an input. Information indicative of an input may relate to information that conveys occurrence of the input, one or more properties of the input, and/or the like. The information indicative of the input may be received from one or more input devices, one or more components of the apparatus that are in, at least indirect communication with one or more input devices, from an external apparatus, and/or the like

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

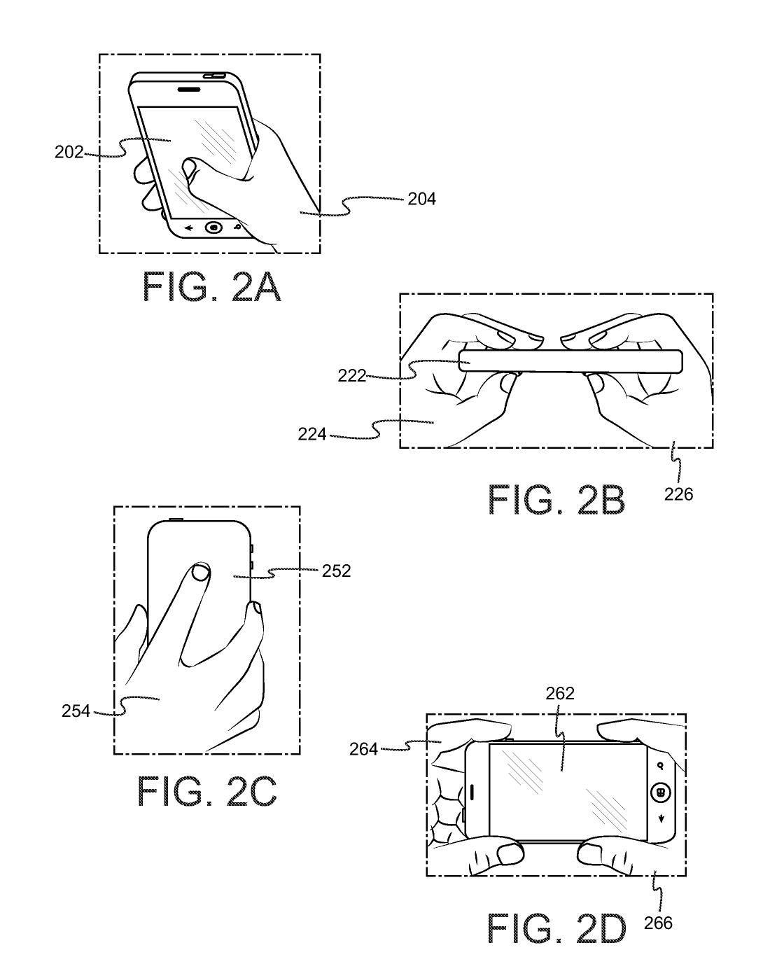

FIGS. 2A-2D are diagrams illustrating grip surfaces according to at least one example embodiment. The examples of FIGS. 2A-2D are merely examples of grip surfaces of an apparatus, and do not limit the scope of the claims. For example, shape of the apparatus may vary, holding configuration of the apparatus may vary, and/or the like.

Many electronic apparatuses are configured to be held by a user. For example, the apparatus may be a mobile phone, a tablet, a personal digital assistant, a camera, a video recorder, a remote control unit, a game console, and/or the like. Such apparatuses may be configured such that surfaces of the apparatus are associated with holding the apparatus. In at least one example embodiment, a surface of the apparatus that is configured to be held by a user is referred to as a grip surface of the apparatus. For example, the apparatus may be designed such that holding the apparatus is facilitated by one or more grip surfaces of the apparatus. For example, the apparatus may be shaped to allow a user to hold the apparatus from the sides of the apparatus, the back of the apparatus, and/or the like. In at least one example embodiment, a surface in which holding the apparatus may cause contact with the apparatus is referred to as a grip surface of the apparatus. For example, even though an apparatus may be configured to be held by a single hand at grip surfaces on opposite sides of the apparatus, the back surface of the apparatus may be contacted by the hand due to the hand holding each side of the apparatus. In this manner, the back of the apparatus may be a grip surface of the apparatus.

The apparatus may have one or more grip surfaces. For example, the user may contact one or more surfaces of the apparatus as a result of holding the apparatus. For example, a grip surface of the apparatus may be at least part of one or more edges of the apparatus, at least part of a back surface of the apparatus, at least part of a handle of the apparatus, and/or the like. In at least one example embodiment, an edge of an apparatus relates to a surface of the apparatus associated with a side of the apparatus, such as a left side, a top side, a bottom side, a right side, and/or the like. In at least one example embodiment, an edge may be characterized by way of being a surface that is neither a front surface nor a rear surface. In at least one example embodiment, a front surface of the apparatus relates to a surface of the apparatus configured to face towards a user when the apparatus is in use. For example, the front of the apparatus may comprise at least one primary display. In such an example, the primary display may be characterized by being the only display of the apparatus, the largest display of the apparatus, the most interactive display of the apparatus, and/or the like. In at least one example embodiment, the back surface of the apparatus is a surface of the apparatus that is opposite to the front surface of the apparatus. For example, the back surface may relate to a surface of the apparatus opposite to a surface associated with a primary display.

FIG. 2A is a diagram illustrating grip surfaces according to at least one example embodiment. The example of FIG. 2A shows apparatus 202 being held in hand 204. It can be seen that the right edge of apparatus 202 and the left edge of apparatus 202 are grip surfaces of apparatus 202. In addition, hand 204 is contacting apparatus 202 at the back surface of apparatus 202 due to hand 204 holding apparatus 202. In this manner, the back surface of apparatus 202 may be a grip surface of apparatus 202.

FIG. 2B is a diagram illustrating grip surfaces according to at least one example embodiment. The example of FIG. 2B shows apparatus 222 being held in hands 224 and 226. It can be seen that the right edge of apparatus 222 and the left edge of apparatus 222 are grip surfaces of apparatus 222. In addition, hands 224 and 226 are contacting apparatus 222 at the back surface of apparatus 222 due to hands 224 and 226 holding apparatus 222. In this manner, the back surface of apparatus 222 may be a grip surface of apparatus 222.

In some circumstances, an apparatus may be configured to be held in multiple orientations, in multiple holding configurations, and/or the like. For example, apparatus 222 may be the same apparatus as apparatus 202 of FIG. 2A. For example, FIG. 2A may depict apparatus 222 being held at a different orientation than the example of FIG. 2B. Therefore, more than two edges of apparatus 222 may be grip surfaces. For example, the apparatus may treat a surface as a grip surface even if the user is not currently holding the apparatus in a manner that holding the apparatus results in contact at the grip surface.

FIG. 2C is a diagram illustrating grip surfaces according to at least one example embodiment. The example of FIG. 2C shows apparatus 252 being held in hand 254. It can be seen that the right edge of apparatus 252 and the left edge of apparatus 252 are grip surfaces of apparatus 252. In addition, hand 254 is contacting apparatus 254 at the back surface of apparatus 252 due to hand 254 holding apparatus 252. In this manner, the back surface of apparatus 252 may be a grip surface of apparatus 252. It can be seen that a finger of hand 254 is contacting apparatus 252 upward from the position at which hand 254 is contacting the surface of apparatus 252. The user may be utilizing such finger position to control the angle of apparatus 252, to stabilize apparatus 252, and or the like. Therefore, even though such finger position may not be necessary for the apparatus to be supported by the user, the upper part of the back surface may be a grip surface by way of the apparatus being configured such that a user may place one or more fingers at the upper part of the apparatus to facilitate holding the apparatus in a desired manner.

FIG. 2D is a diagram illustrating grip surfaces according to at least one example embodiment. The example of FIG. 2D shows apparatus 262 being held in hands 264 and 266. It can be seen that the top edge of apparatus 262 and the bottom edge of apparatus 262 are grip surfaces of apparatus 262.

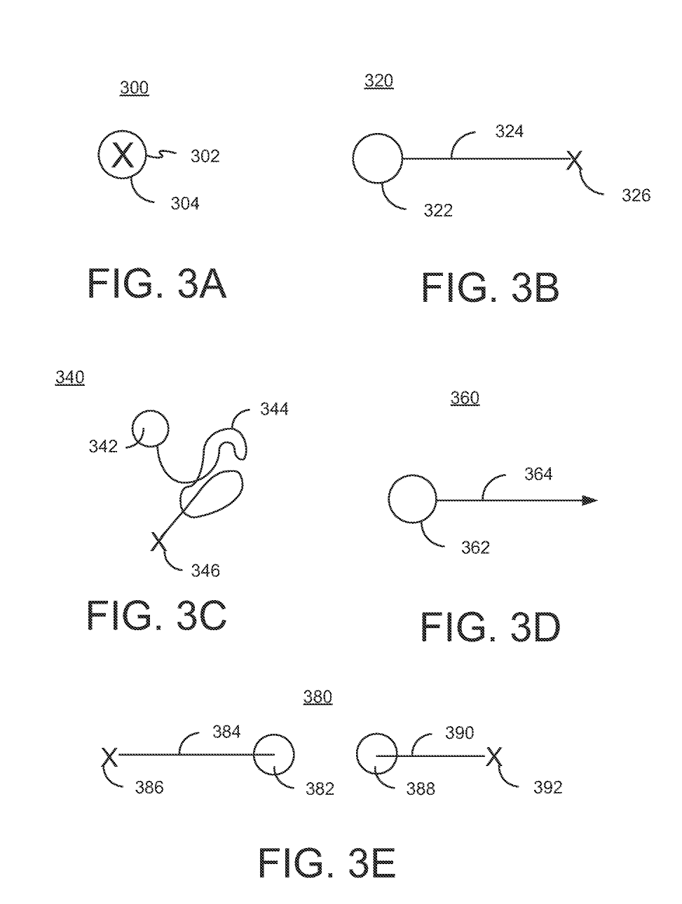

FIGS. 3A-3E are diagrams illustrating touch inputs according to at least one example embodiment. The examples of FIGS. 3A-3E are merely examples of touch inputs, and do not limit the scope of the claims. For example, number of inputs may vary, relationship between inputs may vary, orientation of inputs may vary, and/or the like.

In FIGS. 3A-3E, a circle represents an input related to contact with a touch sensor, such as a touch display, two crossed lines represent an input related to releasing a contact from a touch sensor, and a line represents input related to movement on a touch sensor. Although the examples of FIGS. 3A-3E indicate continuous contact with a touch sensor, there may be a part of the input that fails to make direct contact with the touch sensor. Under such circumstances, the apparatus may, nonetheless, determine that the input is a continuous stroke input. For example, the apparatus may utilize proximity information, for example information relating to nearness of an input implement to the touch sensor, to determine part of a touch input.

It should be understood that, even though touch sensor information is described in terms of contact and release, many touch sensors may determine that a contact occurs when the user's hand is within a threshold distance from the apparatus, without physically contacting the apparatus. Therefore, contact may relate to circumstances where the touch sensor determines that proximity is sufficiently close enough to determine existence of contact. Similarly, release may relate to circumstances where the touch sensor determines that proximity is sufficiently distant enough to determine termination of contact.

In the example of FIG. 3A, input 300 relates to receiving contact input 302 and receiving a release input 304. In this example, contact input 302 and release input 304 occur at substantially the same position. In an example embodiment, an apparatus utilizes the time between receiving contact input 302 and release input 304. For example, the apparatus may interpret input 300 as a tap for a short time between contact input 302 and release input 304, as a press for a longer time between contact input 302 and release input 304, and/or the like.

In the example of FIG. 3B, input 320 relates to receiving contact input 322, a movement input 324, and a release input 326. Input 320 relates to a continuous stroke input. In this example, contact input 322 and release input 326 occur at different positions. Input 320 may relate to dragging an object from one position to another, to moving a scroll bar, to panning a virtual screen, to drawing a shape, and/or the like. In an example embodiment, an apparatus interprets input 320 based at least in part on the speed of movement 324. For example, if input 320 relates to panning a virtual screen, the panning motion may be small for a slow movement, large for a fast movement, and/or the like. In another example embodiment, an apparatus interprets input 320 based at least in part on the distance between contact input 322 and release input 326. For example, if input 320 relates to a scaling operation, such as resizing a box, the scaling may relate to the distance between contact input 322 and release input 326. An apparatus may interpret the input before receiving release input 326. For example, the apparatus may evaluate a change in the input, such as speed, position, and/or the like. In such an example, the apparatus may perform one or more determinations based upon the change in the touch input. In such an example, the apparatus may modify a text selection point based at least in part on the change in the touch input.

In the example of FIG. 3C, input 340 relates to receiving contact input 342, a movement input 344, and a release input 346 as shown. Input 340 relates to a continuous stroke input. In this example, contact input 342 and release input 346 occur at different positions. Input 340 may relate to dragging an object from one position to another, to moving a scroll bar, to panning a virtual screen, to drawing a shape, and/or the like. In an example embodiment, an apparatus interprets input 340 based at least in part on the speed of movement 344. For example, if input 340 relates to panning a virtual screen, the panning motion may be small for a slow movement, large for a fast movement, and/or the like. In another example embodiment, an apparatus interprets input 340 based at least in part on the distance between contact input 342 and release input 346. For example, if input 340 relates to a scaling operation, such as resizing a box, the scaling may relate to the distance between contact input 342 and release input 346. In still another example embodiment, the apparatus interprets the position of the release input. In such an example, the apparatus may modify a text selection point based at least in part on the change in the touch input.

In the example of FIG. 3D, input 360 relates to receiving contact input 362, and a movement input 364, where contact is released during movement. Input 360 relates to a continuous stroke input. Input 360 may relate to dragging an object from one position to another, to moving a scroll bar, to panning a virtual screen, to drawing a shape, and/or the like. In an example embodiment, an apparatus interprets input 360 based at least in part on the speed of movement 364. For example, if input 360 relates to panning a virtual screen, the panning motion may be small for a slow movement, large for a fast movement, and/or the like. In another example embodiment, an apparatus interprets input 360 based at least in part on the distance associated with the movement input 364. For example, if input 360 relates to a scaling operation, such as resizing a box, the scaling may relate to the distance of the movement input 364 from the contact input 362 to the release of contact during movement. In at least one example embodiment, the input of the example of FIG. 3D may be referred to as a swipe input, a flick input, and/or the like.

In an example embodiment, an apparatus may receive multiple touch inputs at coinciding times. For example, there may be a tap input at a position and a different tap input at a different location during the same time. In another example there may be a tap input at a position and a drag input at a different position. An apparatus may interpret the multiple touch inputs separately, together, and/or a combination thereof. For example, an apparatus may interpret the multiple touch inputs in relation to each other, such as the distance between them, the speed of movement with respect to each other, and/or the like.

In the example of FIG. 3E, input 380 relates to receiving contact inputs 382 and 388, movement inputs 384 and 390, and release inputs 386 and 392. Input 320 relates to two continuous stroke inputs. In this example, contact input 382 and 388, and release input 386 and 392 occur at different positions. Input 380 may be characterized as a multiple touch input. Input 380 may relate to dragging an object from one position to another, to moving a scroll bar, to panning a virtual screen, to drawing a shape, to indicating one or more user selected text positions and/or the like. In an example embodiment, an apparatus interprets input 380 based at least in part on the speed of movements 384 and 390. For example, if input 380 relates to zooming a virtual screen, the zooming motion may be small for a slow movement, large for a fast movement, and/or the like. In another example embodiment, an apparatus interprets input 380 based at least in part on the distance between contact inputs 382 and 388 and release inputs 386 and 392. For example, if input 380 relates to a scaling operation, such as resizing a box, the scaling may relate to the collective distance between contact inputs 382 and 388 and release inputs 386 and 392.

In an example embodiment, the timing associated with the apparatus receiving contact inputs 382 and 388, movement inputs 384 and 390, and release inputs 386 and 392 varies. For example, the apparatus may receive contact input 382 before contact input 388, after contact input 388, concurrent to contact input 388, and/or the like. The apparatus may or may not utilize the related timing associated with the receiving of the inputs. For example, the apparatus may utilize an input received first by associating the input with a preferential status, such as a primary selection point, a starting position, and/or the like. In another example, the apparatus may utilize non-concurrent inputs as if the apparatus received the inputs concurrently. In such an example, the apparatus may utilize a release input received first the same way that the apparatus would utilize the same input if the apparatus had received the input second.

Even though an aspect related to two touch inputs may differ, such as the direction of movement, the speed of movement, the position of contact input, the position of release input, and/or the like, the touch inputs may be similar. For example, a first touch input comprising a contact input, a movement input, and a release input, may be similar to a second touch input comprising a contact input, a movement input, and a release input, even though they may differ in the position of the contact input, and the position of the release input.

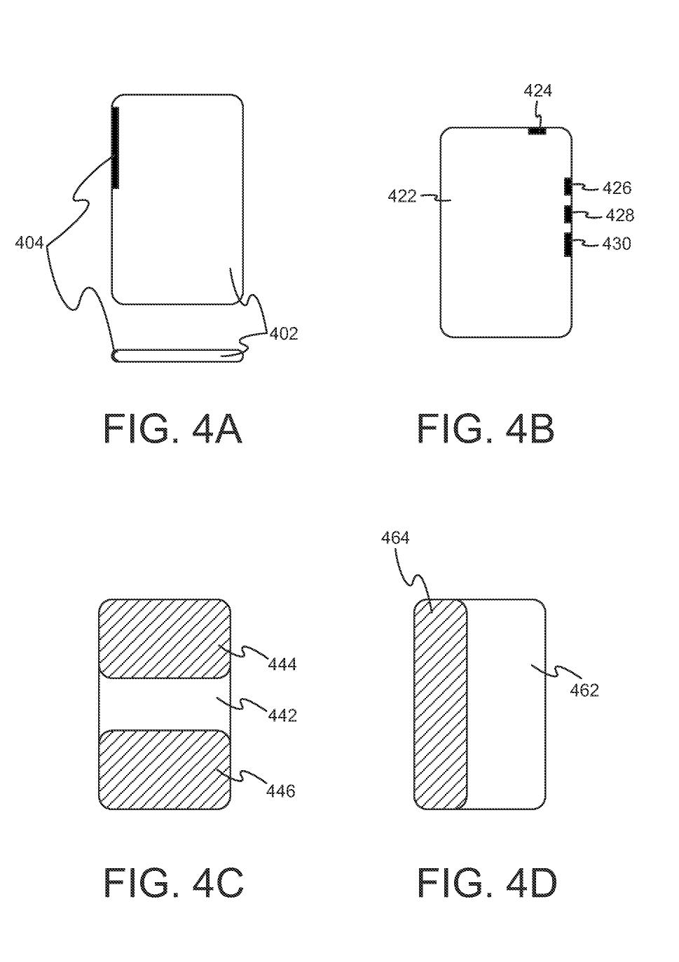

FIGS. 4A-4D are diagrams illustrating regions of a grip surface according to at least one example embodiment. The examples of FIGS. 4A-4D are merely examples of regions of a grip surface, and do not limit the scope of the claims. For example, position of a region may vary, shape of a region may vary, size of a region may vary, and/or the like.

In some circumstances, it may be desirable to provide a way for a user to perform input on a grip surface of the apparatus. For example, the user may desire to perform input using a hand that is holding the apparatus.

In some circumstances, it may be desirable to provide one or more mechanical input actuation devices on a grip surface of the apparatus. For example, it may be desirable to allow a user to perform input on such an actuator by performing actuation of the mechanical input actuation device using the hand that is holding the apparatus. In some circumstances, the physical characteristics of the mechanical input actuation device may be such that the mere holding of the apparatus does not cause actuation of the mechanical input actuation device. For example, actuation of the mechanical input actuation device may be associated with the user applying a greater amount of force to the mechanical input actuation device than the user applies for holding the apparatus.

In some circumstances, it may be desirable to provide a grip surface input device to a user absent utilization of a mechanical input actuation device. For example, the apparatus may utilize a touch sensor, such as a capacitive touch sensor, a resistive touch sensor, and/or the like. Without limiting the scope of the claims in any way, at least one technical effect associated with utilization of a touch sensor instead of a mechanical input actuation device may be to reduce amount of circuit board strain associated with user input, reduce cost of materials of an apparatus, reduce production complexity associated with housing, reduce production complexity associated with construction, and/or the like. In such an apparatus, the touch sensor may or may not correspond to a display. For example, the touch sensor associated with a grip surface of the apparatus may be a touch display, may not be a touch display, and/or the like.

In apparatuses that utilize one or more touch sensors for input at a grip surface of the apparatus, it may be desirable for the apparatus to differentiate inadvertent contact with the apparatus, for example contact associated with holding the apparatus, from input performed by the user. In at least one example embodiment, the apparatus provides for an intent designation input. An intent designation input may be an input that is indicative of a non-accidental touch input. For example, the intent designation input may be an input that is unlikely to be associated with contact resulting from holding the apparatus. For example, the intent designation input may be one or more inputs, such as a sequence of predetermined inputs. In at least one example embodiment, the intent designation input comprises a contact input, a release input, and another contact input that occur within a threshold time. For example, an indication of an input that is indicative of a user tapping and pressing a region of a grip surface may relate to an intent designation input. In at least one example embodiment, the intent designation input comprises two contact inputs occurring together. In at least one example embodiment, the apparatus determines that inputs occur together if the inputs occur within a concurrency time threshold of each other. A concurrency time threshold may relate to a time threshold indicative of a time interval at which a user may be unable to perceive a time difference between inputs. For example, an indication of an input that is indicative of two contact inputs occurring together may relate to an intent designation input. In at least one example embodiment, the intent designation input comprises two contact inputs occurring together, two release inputs occurring together, and two contact inputs occurring together within a threshold time. For example, an indication of an input that is indicative of a user tapping two fingers and pressing a region of a grip surface with the two fingers may relate to an intent designation input.

In at least one example embodiment, the apparatus receives an indication of a touch input that is associated with a region of a grip surface of the apparatus. The apparatus may receive the indication of the touch input from a touch sensor, from a device that receives touch sensor information, from a device that manages touch sensor information, and/or the like. The indication of the touch input may be any information that communicates occurrence of the touch input, identity of the touch input, one or more characteristics of the touch input, and/or the like. In at least one example embodiment, the touch input comprises an intent designation input.

In some circumstances, it may be desirable to allow a user to perform non-trivial input in association with a grip surface of the apparatus. For example, it may be desirable for the user to provide an input that comprises one or more movement inputs, one or more contact inputs, one or more release inputs, and/or the like. In at least one example embodiment, the touch input comprises an interaction input. In at least one example embodiment, the interaction input relates to input provided by the user for the purpose of performing input. For example, interaction input may relate to input that is intentional by the user. In at least one example embodiment, the interaction input is distinct from the intent designation input. For example, the user may perform the intent designation input before performing the interaction input. In this manner, the user may communicate to the device that the interaction input is non-accidental by way of performing the intent designation input. There may be more than one interaction input. For example, the interaction input may be a continuous stroke input. In such an example, the continuous stroke input may comprise a movement input indicative of movement in a direction and another movement input indicative of movement in a different direction.

In at least one example embodiment, the interaction input is subsequent to the intent designation input. For example, the apparatus may determine the interaction input based, at least in part, on input subsequent to an intent designation input. In at least one example embodiment, the apparatus determines the interaction input based, at least in part, the touch input being indicative of continuous contact between the intent designation input and the interaction input. For example the apparatus may determine the interaction input to be a continuous stroke input having a contact input that is part of the intent designation input, that is received within a time threshold from the intent designation input, and/or the like.

In at least one example embodiment, the interaction input relates to a movement input subsequent to the intent designation input. For example, the interaction input may relate to a sliding input. For example, the sliding input may be utilized to adjust a camera focus, a volume setting, a zoom level, a flash brightness, a value of a setting, and/or the like.

In at least one example embodiment, the interaction input relates to an increase in a force of the touch input subsequent to the intent designation input. The apparatus may determine an increase in force by determining an increase in the size of a contact region of the touch input, by way of one or more force sensors, and/or the like. In at least one example embodiment, the interaction input relates to the force surpassing a threshold force. For example, the threshold force may be similar to a force associated with actuation of a mechanical input actuation device.

In at least one example embodiment, the intent designation input relates to a plurality of contact regions within the region, and the interaction input relates to a movement of the contact regions. For example, the movement of the contact regions may relate to a change in distance between the contact regions, similar as described regarding FIG. 3E. In another example, the movement of the contact regions may relate to a change in position of the contact regions within a region of the grip region. Such change in position may be similar as movement 324 of FIG. 3B.

In some circumstances, the touch input may comprise one or more inputs prior to the intent designation input. In at least one example embodiment, the apparatus disregards inputs prior to an intent designation input. Without limiting the scope of the claims in any way, at least one technical effect associated with disregarding inputs prior to a an intent designation input may be to avoid performing an operation in response to an inadvertent input, avoiding input prior to an intent designation input from being considered as an interaction input, and/or the like.

In at least one example embodiment, the apparatus may determine that a received touch input comprises at least one intent designation input. For example, the apparatus may disregard touch input associated with a region of a grip surface absent determination that the touch input comprises at least one intent designation input. In at least one example embodiment, determination of whether a touch input comprises an intent designation input is predicated by the touch input being associated with a region of the grip surface. For example, if the touch input is associated with a region of a non-grip surface, for example on the front surface of an apparatus, on a primary display of an apparatus, and/or the like, the apparatus may perform an operation based, at least in part, on the touch input without regard for whether the touch input comprises an intent designation input. For example, the apparatus may receive an indication of a touch input that is unassociated with a region of a grip surface. In such an example, the apparatus may perform an operation based, at least in part, on the touch input absent consideration of an intent designation input.

In at least one example embodiment, the apparatus determines that the touch input is associated with the grip surface. For example, the apparatus may determine that the touch input is associated with a touch sensor associated with a grip surface, that the touch input is associated with a region of a touch sensor that is associated with a grip surface, and/or the like.

In at least one example embodiment, the apparatus determines that the touch input comprises at least one interaction input. The apparatus may determine the interaction input to be touch inputs that occur subsequent to the intent designation input, touch inputs that are part of a continuous stroke input in which the contact input of the continuous stroke input is comprised by the intent designation input, and/or the like. In at least one example embodiment, determination that the touch input comprises at least one interaction input is predicated by determination that the touch input comprises the intent designation input.

In some circumstances, it may be desirable to provide a user with feedback associated with an intent designation input. For example, a user may desire sensory feedback similar to the sensory feedback associated with actuation of a mechanical input actuation device, clicking of a button, and/or the like. In at least one example embodiment, the apparatus may cause rendering of at least one haptic signal in association with determination of the intent designation input. In at least one example embodiment, rendering of a haptic signal relates to invoking a vibration signal, a tactile signal, and/or the like. It should be understood that there are many methods and devices for providing haptic signals to a user, and that there will be many more methods and devices that will be provided in the future for providing haptic signals to a user, and that the claims are not limited by such methods and devices. In at least one example embodiment the apparatus may cause rendering of a haptic signal based, at least in part, on determination that the touch input comprises an intent designation input, comprises a part of an input designation input, and/or the like. Without limiting the scope of the claims in any way, at least one technical effect associated with rendering the haptic signal in association with determination of the intent designation input may be to allow the user to understand that the apparatus has perceived, at least part of, an intent designation input. In such circumstances, the user may take action to avoid inadvertent input, may gain confidence in performance of an intentional input, and/or the like.

In at least one example embodiment, the apparatus performs an operation associated with a grip surface touch input based, at least in part, on the intent designation input. For example, the apparatus may perform the operation in response to the intent designation input, in response to an interaction input, and/or the like. In at least one example embodiment, the apparatus precludes performance of the operation associated with a grip surface touch input based, at least in part, on the grip surface touch input failing to comprise the intent designation input. For example, the apparatus my preclude preforming an operation in response to the grip surface touch input based at least in part on the grip surface touch input failing to comprise an intent designation input.

In at least one example embodiment, the operation is based, at least in part on the intent designation input. For example, the intent designation input may relate to a region of the grip surface of the apparatus. In such an example, the operation may be based, at least in part on the region of the grip surface. The region may be any region partitioned by the apparatus. For example, different regions may relate to different grip surfaces, different parts of the same grip surface, different touch sensors, different parts of the same touch sensor, and/or the like. For example, the apparatus may perform an operation based, at least in part, on the intent designation input being associated with a region and perform a different operation based, at least in part, on the intent designation input being associated with a different region.

As previously described, the touch input may comprise inputs prior to the intent designation input. In such circumstances, the operation may be independent of the input prior to the intent designation input. For example, the apparatus may determine the operation absent consideration of the input prior to the intent designation input.

In at least one example embodiment, the operation is based, at least in part on the interaction input. For example, performance of the operation may be predicated on performance of a predetermined interaction input associated with the operation. In such an example, the predetermined interaction input may relate to an interaction input that is designated to cause invocation of the operation. For example, a tap input may be associated with causation of invocation of an operation, a slide input may be associated with causation of setting a value of a parameter, and/or the like. For example, a tap interaction input may relate to performing an adjustment of a parameter by an increment, skipping to a next song, skipping to a previous song, toggling enablement of a camera flash, taking a photo, toggling enablement of a display, toggling enablement of a lock, and/or the like. In another example, a slide interaction input may relate to a continuous adjustment, such as volume control, zoom control, camera white balance control, camera brightness control, scrolling up or down, paging up or down, panning backwards or forwards, and/or the like.

In some circumstances, an apparatus may comprise platform software that causes the apparatus to perform in a predetermined manner that complies with an associated platform. For example, a platform may be an operating system, an operating environment, a performance specification, and/or the like. For example, the platform may be a Microsoft Windows® platform, a Google Android® platform, and/or the like. In such circumstances, it may be desirable for the apparatus to comply with one or more platform compliance criteria. A platform compliance criteria may relate to a designated set of directives that the apparatus should fulfill in order to be deemed compliant with the platform. For example, identification of an apparatus as an apparatus of the specified platform may be predicated on the apparatus satisfying the platform compliance criteria.

In at least one example embodiment, a platform compliance criteria may specify one or more input actuation devices to be comprised by the apparatus. For example, the platform compliance criteria may specify presence of a power button, a camera button, a home button, a volume up button, a volume down button, a back button, a search button, and/or the like. In such circumstances, the platform compliance criteria may specify platform operations to invoke in response to receiving input associated with such specified input actuation devices. For example, the platform compliance criteria may specify that, under some circumstances, actuation of the home button causes the apparatus to present a home screen to the user, actuation of the camera button causes a camera program to run, actuation of the camera button causes the camera program to capture an image, actuation of the volume up button causes the apparatus volume to increase, and/or the like. In this manner, the operation may be associated with an input button of a platform compliance criteria. In at least one example embodiment, the apparatus may perform an operation that relates to invocation of a platform input directive that identifies the button input of the platform compliance specification. For example, platform input directive may relate to a function call, a message, and/or the like, to be invoked upon receipt of an input invoking the button press.

As previously described, it may be desirable to utilize one or more touch sensors instead of utilizing one or more mechanical input actuation devices. In such circumstances, it may be desirable to map a touch input to a button input of the platform software. For example, based, at least in part, on determining that a touch input associated with a region of a grip surface comprises an intent designation input, the apparatus may invoke a platform input directive associated with a button input specified by the platform compliance criteria. In at least one example embodiment, mapping may relate to determining a platform invocation directive to associate with an input, such as an intent designation input associated with a region of a grip surface of the apparatus.

FIG. 4A is a diagram illustrating regions of a grip surface according to at least one example embodiment. The example of FIG. 4A illustrates region 404 of a grip surface of apparatus 402. It can be seen that the grip surface associated with region 404 is an edge of the apparatus. In at least one example embodiment, the apparatus causes performance of an operation based, at least in part, on determining that a touch input associated with region 404 comprises an intent designation input. The apparatus may comprise one or more touch sensors that correlate to region 404.

FIG. 4B is a diagram illustrating regions of a grip surface according to at least one example embodiment. The example of FIG. 4B illustrates regions 424, 426, 428, and 430 of at least one grip surface of apparatus 422. It can be seen that the grip surface associated with region 424 is a top edge of the apparatus and the grip surface associated with regions 426, 428, and 430 is a right edge of the apparatus. In at least one example embodiment, the apparatus causes performance of an operation based, at least in part, on determining that a touch input associated with region 426 comprises an intent designation input. In at least one example embodiment, the apparatus causes performance of a different operation based, at least in part, on determining that a touch input associated with region 428 comprises an intent designation input. For example, region 424 may relate to a power operation, region 426 may relate to a volume up operation, region 428 may relate to a volume down operation, region 430 may relate to a camera operation, and/or the like. The apparatus may comprise one or more touch sensors that correlate to regions 424, 426, 428, and 430.

FIG. 4C is a diagram illustrating regions of a grip surface according to at least one example embodiment. The example of FIG. 4C illustrates regions 444 and 446 of at least one grip surface of apparatus 442. It can be seen that the grip surface associated with regions 444 and 446 is a back surface of the apparatus. In at least one example embodiment, the apparatus causes performance of an operation based, at least in part, on determining that a touch input associated with region 446 comprises an intent designation input. In at least one example embodiment, the apparatus causes performance of a different operation based, at least in part, on determining that a touch input associated with region 444 comprises an intent designation input. For example, region 444 may relate to a volume up operation, region 446 may relate to a volume down operation, and/or the like. The apparatus may comprise one or more touch sensors that correlate to regions 444 and 446.

FIG. 4D is a diagram illustrating a region of a grip surface according to at least one example embodiment. The example of FIG. 4D illustrates region 464 of a grip surface of apparatus 462. It can be seen that the grip surface associated with region 464 is a back surface of the apparatus. In at least one example embodiment, the apparatus causes performance of an operation based, at least in part, on determining that a touch input associated with region 464 comprises an intent designation input. For example, region 464 may relate to a volume operation. For example, an interaction input comprising a movement input may cause change in a value of the volume. The apparatus may comprise one or more touch sensors that correlate to region 464.

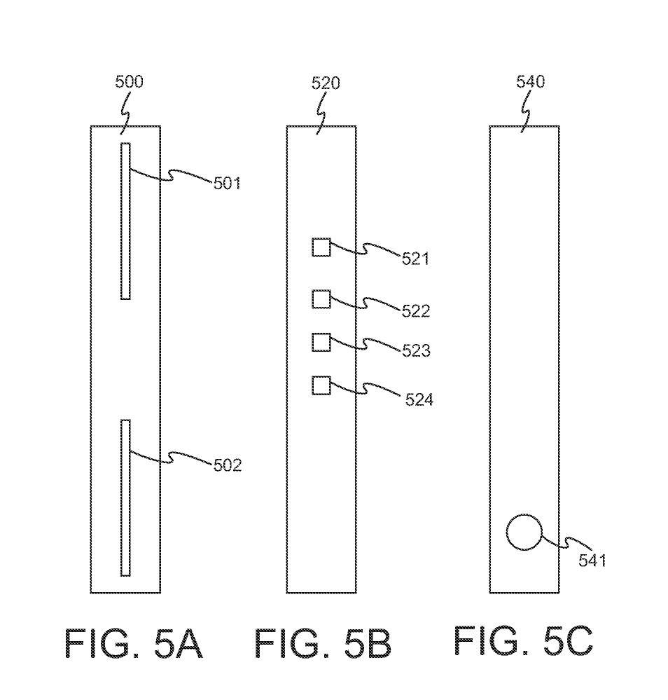

FIGS. 5A-5C are diagrams illustrating indications of regions according to at least one example embodiment. The examples of FIGS. 5A-5C are merely examples, and do not limit the scope of the claims. For example, position of an indication may vary, shape of an indication may vary, size of an indication may vary, and/or the like.

In at least one example embodiment, the apparatus may comprise at least one indication of a region of a grip surface of the apparatus associated with an operation. The indication may be a textural indication, a visual indication, and/or the like.

A textural indication may relate to one or more surface concavities, one or more surface convexities, and/or the like. For example, the textural indication may identify one or more boundaries of the associated region. In another example, the textural indication may be indicative of an operation associated with the region. In another example, the textural indication may be indicative of an interaction input that may be performed in association with the region.

A visual indication may relate to one or more visual representation. The visual indication may be a visual representation upon a surface of the apparatus, such as a label. The visual indication may be a visual indication provided by a display. For example, the touch sensor associated with a region of a grip surface of the apparatus may relate to a touch display. The visual indication may identify one or more aspect of the region. For example, the visual indication may identify one or more boundaries of the associated region. In another example, the visual indication may be indicative of an operation associated with the region. In another example, the visual indication may be indicative of an interaction input that may be performed in association with the region. Even though the examples of FIGS. 5A-5C are discussed in relation to textural indicators, some example embodiments may utilize visual indictors, and/or other types of indicators.

FIG. 5A is a diagram illustrating indications of a grip surface according to at least one example embodiment. In the example of FIG. 5A, grip surface 500 comprises textural representation 501, which is a raised ridge forming a track for sliding in association with another region, and textural representation 502, which is another raised ridge forming a track for sliding in association with another region. It can be seen that in resembling a ridge for sliding, textural representations 501 and 502 are indicative of a movement input associated with a slider interface element. Such a textural representation may be indicative of adjustment of a value of a setting.

FIG. 5B is a diagram illustrating indications of grip surface 520 according to at least one example embodiment. In the example of FIG. 5B, textural representations 521, 522, 523, and 524 are raised ridges that indicate particular regions of a grip surface. In the example of FIG. 5B, one or more of textural representations 521, 522, 523, and 524 may indicate a region associated with a shutter release operation, may indicate a region input for zoom of a camera program, may indicate an operation for setting a value associated with operation of a flash, and/or the like. Textural representations 521, 522, 523, and 524 may be indicative of selectable buttons on the edge of an apparatus.

In at least one embodiment, even though an indicator may signify a region, the region associated with the indicated input may be larger than the identifier. For example, an indicator may represent a button. However, in such an example, the region may be larger than the indication of a button. In such circumstances, it may be desirable to provide an indication of a boundary of the region.

FIG. 5C is a diagram illustrating an indication of a grip surface according to at least one example embodiment. In the example of FIG. 5C, grip surface 540 comprises textural indication 541, which relates to a raised circle indicative of a selectable button. In at least one example embodiment, textural indication 541 identifies a region of grip surface 540 that may receive input, such as a tap input, a press input, and/or the like.

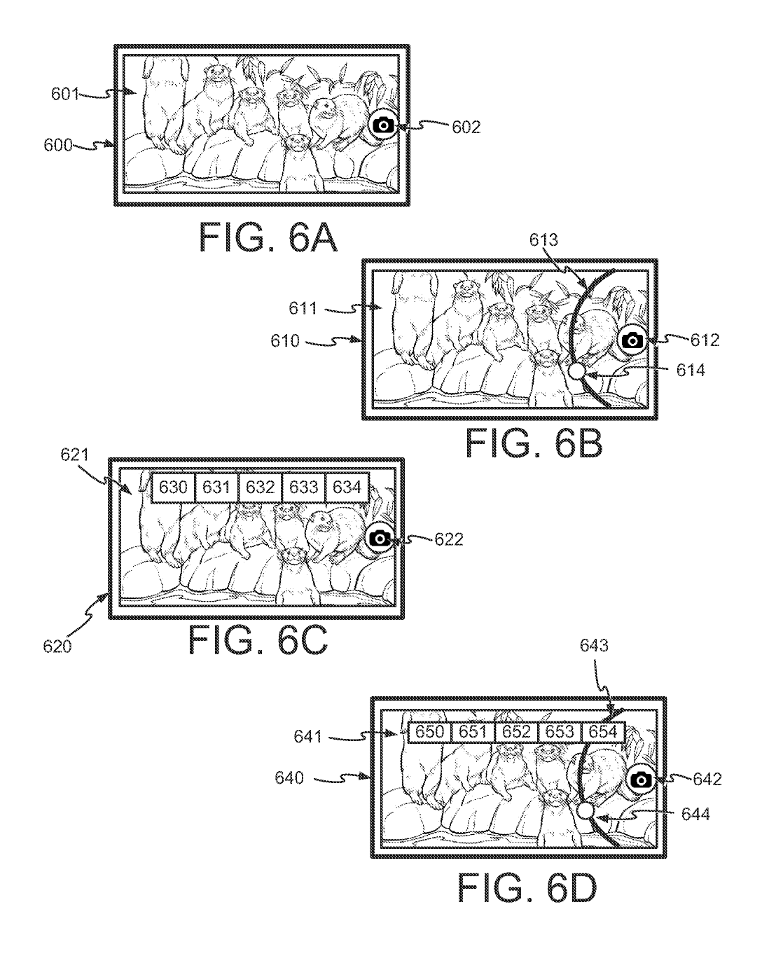

FIGS. 6A-6D are diagrams illustrating information displayed in association with adjustment of a value of a setting according to at least one example embodiment. The examples of FIGS. 6A-6D are merely examples, and do not limit the scope of the claims. For example, representation of information may vary, arrangement of elements may vary, orientation of the display may vary, and/or the like.

As touch displays have become more ubiquitous on various types of electronic apparatuses, the proportion of the surface of electronic apparatuses that are allocated to a display has increased. In this manner, users now enjoy much larger displays for similarly sized apparatuses than in previous times. With such expansion of touch display utilization, users have become accustomed to performing inputs by way of a touch display. Performance of input on a touch display often includes the user placing a hand, finger, stylus, and/or the like, on the display. In such circumstances, such touch input may, at least partially, occlude a portion of the display. For example, the display may be occluded at a region where the contact takes place, at a region beneath an object performing the contact, etc. For example, a user may perform a touch input with his finger. In such an example, the region of the display in which the user's finger is contacting the display may be occluded by such contact. However, the rest of the user's finger, the user's hand, the user's arm, and/or the lie, may also occlude, at least part of, the display. In some circumstances, it may be desirable to reduce occlusion of the display associated with a touch display touch input.

In some circumstances, the apparatus may provide information indicating a region of a touch display in which the user may perform input, such as a button, an icon, a slider, and/or the like. In some circumstances, such information may, at least partially occlude other information to be presented on the display. For example, there may be an image upon with the information is overlain. In such an example, the information may, at least partially, occlude the image.

In at least one example embodiment, it may be desirable to avoid occlusion of content to be presented on a display by performance of a display touch input, by provision of interface elements associated with a display touch input, and/or the like. For example, even though it may be desirable to provide for some interface elements on a touch display, it may be desirable to provide for interaction by way of another input that does not occlude any part of the display.

For example, many applications benefit from the user being capable of viewing as much of the display as possible, such as image capturing applications, gaming applications, and/or the like. In such circumstances, the user may benefit from being able to perceive content that would otherwise be occluded by interface elements, by an object performing an input, and/or the like. For example, it may be desirable to provide for input of an image capture application, such as an image viewfinder interface, that utilizes touch input associated with a grip surface of the apparatus. In such circumstances, the apparatus may avoid obscurance, by interface elements of object performing input, of an image that the user may desire to capture. For example, it may be desirable for a user to be able to adjust one or more image settings without necessarily obscuring any portion of the display, with reduced obscurance of the display, and/or the like. For example, it may be desirable to perform a setting adjustment absent any interface elements on the display, absent any interface elements beyond an indication of the setting, absent any interface elements beyond an indication of the setting and an indication of the value of the setting, absent any interface elements beyond a list of settings that may be modified, an indication of the setting, and an indication of the value of the setting.

In some circumstances, it may be desirable to allow the user to utilize regions of a grip surface for adjusting one or more settings, such as one or more camera settings of a viewfinder application. In such an example, the user may perform an input associated with a first region of a grip surface to identify a setting to be adjusted, and may perform a different input to instruct the apparatus regarding how to adjust the value of the setting. Without limiting the scope of the claims in any way, at least one technical effect associated with a separate input for selection of a setting and a separate input for adjustment of the input may be to allow for a consistent region associated with adjustment of a setting such that the user may readily understand how to adjust a setting that the user has not previously adjusted, based on the users experience in adjusting other settings.

FIG. 6A is a diagram illustrating information displayed in association with adjustment of a value of a setting according to at least one example embodiment. In the example of FIG. 6A, apparatus 600 is displaying content on display 601. In at least one example embodiment, the content relates to an image associated with a viewfinder. For example, apparatus 600 may be running an image capture program such that content displayed on display 601 is indicative of an image that may be captured. It can be seen that interface item 602 may relate to an image capture operation. For example, the user may perform a touch input at a position of display 601 that corresponds with interface element 602 to invoke an image capture operation. In some circumstances, it may be desirable for the user to be able to adjust one or more settings while avoiding undue obscurance of the content displayed in relation to the viewfinder.

In at least one example embodiment, an apparatus provides for input by way of one or more grip surfaces for adjustment of a value of one or more settings. A setting may relate to any parameter of the apparatus that may be adjustable. For example a setting may relate to a volume level, a brightness level, and/or the like. In some circumstances a setting may relate to a program setting. In at least one example embodiment, a program setting relates to a setting that governs one or more aspects for the program. For example, a program setting of an image capture program may relate to a shutter speed setting, a color balance setting, a flash setting, a zoom setting, a resolution setting, and/or the like. In at least one example embodiment, a setting has a value. For example, the value may indicate how the setting should affect the apparatus. For example, the value may be an integer value, a floating point value, and enumerated value, a Boolean value, and or the like. For example a value of a flash setting may be a Boolean value that indicates the flash to be on or off, may be an integer value that provides a scale for brightness of the flash, and/or the like. In at least one example embodiment, adjustment of the setting relates to adjustment of the value of the setting. For example, adjustment of the value of the setting may comprise changing the value of the setting to a different value. In another example, the value of a lens setting may be a particular lens type from an enumerated set of lens types. For example, the setting may relate to a lens selection and the value of the setting may be a particular lens type from an enumerated set of lens types. In still another example, the value of a sharing setting may relate to a value that indicates a medium for sharing information, such as an email account, a social media account, a particular communication channel, etc., a contact record that designates a recipient, such as a phonebook entry, an email address, a phone number, a screen name, etc., and/or the like.

The apparatus may provide for input by way of one or more grip surfaces for adjustment of a value of one or more settings, similar as described regarding the examples of FIGS. 4A-4D, FIGS. 5A-5C, and/or the like. For example, the apparatus may associated one or more regions of one or more grip surfaces with a particular setting, may associate one or more regions of one or more grip surfaces with an adjustment of a value, and/or the like. For example, the apparatus may comprise textural indicators similarly as described regarding FIG. 5B such that the program associates a region of the grip surface that corresponds with the textural indicator with a setting. For example, textural indicator 521 may indicate a region of the grip surface that is associated with selection of a particular setting. Similarly, textural indicators 501 and/or 502 may indicate a particular type of setting adjustment. In this manner, the textural indicator may identify one or more regions of the grip surface with one or more settings that may be selected, one or more ways to adjust a value of a selected setting, and/or the like. Even though textural indicators may be helpful for the user to perceive one or more regions of the grip surface that may be associated with an input, other manners may be utilized to allow the user to understand such regions. For example, there may be a visual indicator, on the grip surface, an inference of the region on a display, or even a complete absence of any indicator. For example, the user may associate a particular region of a grip surface with a particular setting or adjustment absent any indicator of the region.

In at least one example embodiment, an apparatus relies upon two inputs for performance of adjustment of a setting. The apparatus may receive an input indicative of selection of a particular setting, and receive an indication of another input indicative of adjustment of the selected setting. In at least one example embodiment, the input indicative of the adjustment of the value is concurrent with the input indicative of the selection of the setting. For example, the apparatus may preclude adjustment of the setting absent concurrency between the input indicative of selection of the setting and the input indicative of the adjustment of the setting. In at least one example embodiment, the input indicative of the selection of the setting is a separate input from the input indicative of the adjustment of the setting. For example, the inputs may be associated with different regions of the grip surface, associated with different grip surfaces, and/or the like. For example, the input associated with selection of the setting may be associated with a top edge of the apparatus and the input associated with adjustment of the setting may be associated with a bottom edge of the apparatus. In another example, the input associated with selection of the setting may be associated with a region of a top edge of the apparatus and the input associated with adjustment of the setting may be associated with a different region of the top edge of the apparatus

In at least one example embodiment, an apparatus that receives a first touch input associated with a region of a grip surface determines whether the first touch input is a setting designation input. In at least one example embodiment, a setting designation input relates to a touch input that identifies one or more settings to be adjusted. In at least one example embodiment, the setting designation unambiguously identifies a setting. For example, there may be a single setting, or a distinct group of settings that a setting designation input designates. For example the region may be a region that is predetermined to be a region associated with selection of the setting. In at least one example embodiment, that the first touch input is a setting designation input that designates the setting for adjustment is based, at least in part, on position of the first touch input. For example, the determination that the first touch input is a setting designation input that designates the setting for adjustment may be based, at least in part, on correlation of a position of the first touch input and a position associated with at least one textural indicator, a position included within a predetermined region associated with the setting, and/or the like. In at least one example embodiment, a setting designation input relates to an intent designation input.

In at least one example embodiment, the first touch input comprises a contact input and a release input, similarly as described regarding FIGS. 3A-3E. In at least one example embodiment, the apparatus allows adjustment of a value of the setting during a time period between the contact input of the first touch input and the release input of the first touch input. In this manner, the performance of adjustment of the value of the setting may be predicated by continued contact of the first touch input during receipt of the second touch input.

In at least one example embodiment, the apparatus receives an indication of a second touch input. The second touch input may be associated with a different region of a grip surface of the apparatus than the first input, and be separate from the first touch input. In at least one example embodiment, the apparatus performs adjustment of a value of the setting based, at least in part, on the second touch input. For example, while the first input is being performed to be a setting designation input that identifies the setting for adjustment, the second input causes the apparatus to perform adjustment of the value of the setting. In some circumstances, the second touch input corresponds with at least one predetermined grip region associated with adjustment of the setting. In at least one example embodiment, the apparatus predicates adjustment of the setting upon determination that the second touch input corresponds with at least one predetermined grip region associated with adjustment of the setting. For example, the predetermined region may be a region that is predetermined to be associated with adjustment absent regard for the particular setting, predetermined to be associated with a group of settings that includes the setting, predetermined to be associated particularly with adjustment of the setting, and/or the like.

In some circumstances, the first touch input and the second touch input may be absent a touch input at a position on a touch display. For example, the touch sensor of a touch display may be unassociated with the receipt of the first touch input and/or receipt of the second touch input. In at least one example embodiment, the first touch input and the second touch input are absent motion of the apparatus. For example, it may be desirable for the user to be able to maintain position of the apparatus, direction of the apparatus, orientation of the apparatus, and/or the like, when performing the first input and/or the second touch input. For example, the setting may relate to an image capture setting. In such an example the user may desire to avoid motion of the apparatus. In such an example, the first input and the second input may be absent inclusion of information indicative of motion. In this manner, the first input and the second input may be non-motion inputs.

In at least one example embodiment, the apparatus causes display of a setting indicator that identifies the setting. In at least one example embodiment, causation of display comprises display information, sending information to a separate apparatus to be displayed, and/or the like. The setting indicator may be a graphical representation that indicates the setting, may be a textual indication that indicates the setting, and/or the like. For example, the setting may relate to a shutter speed setting, and the graphical representation may relate to an icon that resembles a camera shutter. In at least one example embodiment, the apparatus causes display of the setting indicator based on the determination that the first input is a setting designation input. In this manner, the user may identify the setting associated with the input that the user is performing. For example the user may have inadvertently selected the setting may have inadvertently performed the input, and/or the like, such that display of the setting indicator may cue the user to the inadvertent circumstances. In at least one example embodiment, the apparatus causes termination of display of the setting indicator. Causation of termination of display of information may relate to cessation of display of the information, causation of a separate apparatus to cease display of the information, and/or the like.

In at least one example embodiment, the apparatus causes display of an indication of the value of the setting. For example, upon determination that the first input is a setting designation input, the apparatus may cause display of information indicative of the value of the setting. Similarly, upon performing adjustment of the value of the setting, the apparatus may cause display of an indication of the value of the setting. In this manner, the user may be aided in perceiving the setting that is designated for adjustment, the value of the setting prior to adjustment, the value of the setting after adjustment, and/or the like. The indication of the value of the setting may relate to a graphical representation of the value. The graphical representation of the value may relate to a level of shading that indicates the value, a graphical representation that indicates the value as a position along a line, and/or the like. The indication of the value of the setting may relate to a textual representation of the value. For example, the indication of the value of the setting may be text that shows a number that corresponds with the value of the setting. In at least one example embodiment, causation of display of the indication of the value of the setting is caused by receipt of the first touch input, caused by determination that the first touch input is a setting designation input, and/or the like.

In at least one example embodiment, causation of display of the indication of the value of the setting is caused by receipt of the second touch input, caused by adjustment of the value of the setting, and/or the like. In at least one example embodiment, the apparatus causes termination of display of the indication of the value of the setting. In at least one example embodiment, the termination of display of the indication of the value of the setting is caused by the receipt of the release input of the first touch input. In at least one example embodiment, the termination of display of the indication of the value of the setting is caused by receipt of a release input of the second touch input. In this manner, the display of the value of the setting may be reduced to coincide with a time period in which the user is performing input that may cause adjustment of the value of the setting. In this manner, the content that may be displayed may be less occluded, may be occluded for less time, and/or the like.

FIG. 6B is a diagram illustrating information displayed in association with adjustment of a value of a setting according to at least one example embodiment. In the example of FIG. 6B, apparatus 610 is displaying content on display 611. In at least one example embodiment, the content relates to an image associated with a viewfinder. For example, apparatus 610 may be running an image capture program such that content displayed on display 611 is indicative of an image that may be captured. It can be seen that interface item 612 may relate to an image capture operation. For example, the user may perform a touch input at a position of display 611 that corresponds with interface element 612 to invoke an image capture operation. In the example of FIG. 6B, apparatus 610 has caused display of a graphical indication of the value of a setting. The graphical indicator of the example of FIG. 6B comprises line 613 and value indication point 614, such that position of value indication point 614 along line 613 indicates the value of the setting. For example, proximity of value indication point towards the bottom of the display may be indicative of a lower value than proximity to the top of the display.

In at least one example embodiment, the apparatus display of a plurality of indicators of adjustable settings. In at least one example embodiment, an adjustable setting relates to a setting that may be selected for adjustment, for example by a setting designation input. For example, there may be a plurality of settings that a user may select to adjust. In such an example, there may be indicators of adjustable settings that identify, at least some of, the settings that the user may select for adjustment. In at least one example embodiment, the setting indicator previously described relates to a setting indicator that identifies one of the indicators of the plurality of indicators of adjustable settings as the setting. For example, the setting indicator may be a difference between the indicator of the adjustable setting that corresponds to the setting, and the other indicators of the adjustable settings. For example, the setting indicator may relate to a highlighted indicator of an adjustable setting, an adjustable setting that comprises a value indicator, and/or the like.

FIG. 6C is a diagram illustrating information displayed in association with adjustment of a value of a setting according to at least one example embodiment. In the example of FIG. 6C, apparatus 620 is displaying content on display 621. In at least one example embodiment, the content relates to an image associated with a viewfinder. For example, apparatus 620 may be running an image capture program such that content displayed on display 621 is indicative of an image that may be captured. It can be seen that interface item 622 may relate to an image capture operation. It can be seen that the example of FIG. 6C comprises indicators 630, 631, 632, 633, and 634 of adjustable settings.

In at least one example embodiment, position of the indicators of adjustable settings may be indicative of a region of a grip surface that corresponds with a setting designation input. It can be seen that indicators 630, 631, 632, 633, and 634 of adjustable settings are proximate the top edge of apparatus 620. In this manner, the proximity of the indicators of adjustable settings to the top edge of the apparatus may be indicative of regions of the top edge of the apparatus comprising one or more grip regions associated with one or more setting designation inputs for the settings of the setting adjustment indicators.

In at least one example embodiment, determination that the first touch input is a setting designation input that designates the setting for adjustment is based, at least in part, on alignment of a position of the first touch input and a setting indicator that identifies the setting along a common axis. The common axis may relate to a vertical axis, a horizontal axis, and/or the like. For example, a region of the top edge of apparatus 620 that is vertically aligned with setting indicator 630 may relate to a region associated with a setting designation input that designates the setting of setting indicator 630.

In some circumstance, the apparatus may cause display of the indicators of adjustable settings absent receipt of the first input. In such an example, the indicators of adjustable settings may indicate one or more regions of a grip surface associated with a setting designation input for one or more of the adjustable settings, and the user may desire to have a visual indication of such region on the display.

In at least one example embodiment, causation of display of the plurality of indicators of adjustable settings is caused by receipt of the second touch input, caused by adjustment of the value of the setting, and/or the like. In at least one example embodiment, the apparatus causes termination of display of the plurality of indicators of adjustable settings. In at least one example embodiment, the termination of display of the plurality of indicators of adjustable settings is caused by the receipt of the release input of the first touch input. In at least one example embodiment, the termination of display of the plurality of indicators of adjustable settings is caused by receipt of a release input of the second touch input. In this manner, the display of the plurality of indicators of adjustable settings may be reduced to coincide with a time period in which the user is performing input that may cause adjustment of the value of the setting. In this manner, the content that may be displayed may be less occluded, may be occluded for less time, and/or the like.

Even though the information that may be displayed are described separately from each other, various embodiments may include various aspects of the information to be displayed. For example, an apparatus may combine any part of the information displayed in the examples of FIGS. 6A-6C, and/or anything similar. In another example, an apparatus may combine any plurality of parts of the information displayed in the examples of FIGS. 6A-6C.

FIG. 6D is a diagram illustrating information displayed in association with adjustment of a value of a setting according to at least one example embodiment. In the example of FIG. 6D, an embodiment is shown that combines displayed information of FIG. 6C with displayed information of FIG. 6B.

In the example of FIG. 6D, apparatus 640 is displaying content on display 641. It can be seen that interface item 642 may relate to an image capture operation. It can be seen that the example of FIG. 6D comprises indicators 650, 651, 652, 653, and 654 of adjustable settings. In the example of FIG. 6D, apparatus 640 has caused display of a graphical indication of the value of a setting. The graphical indicator of the example of FIG. 6D comprises line 643 and value indication point 644, such that position of value indication point 644 along line 643 indicates the value of the setting. In at least one example embodiment, the setting of the graphical indication of the value of the setting relates to one of the settings of indicators 650, 651, 652, 653, and 654 of adjustable settings.

In at least one example embodiment, the setting relates to performance of an operation. For example, the setting may relate to an image capture setting, such as a lens selection setting, a flash setting, a shutter speed setting, a communication setting, an account selection setting, and/or the like. In at least one example embodiment, the apparatus performs the operation in conformance with the value of the setting. Performance of the operation in conformance with the value of the setting may relate to the performance of the operation being based, at least in part, on the value of the setting. For example, the apparatus may perform the operation based on a value of the setting, and perform the operation differently based, at least in part, on a different value of the same setting. For example, an image capture operation may be performed in conformance with a flash utilization setting. In such an example, the image capture operation may condition utilization of the flash based, at least in part, on the value of the flash utilization setting. For example, if the flash utilization setting indicates flash enablement, the image capture operation may invoke utilization of the flash based, at least in part, on the flash enablement value of the flash utilization setting.

In at least one example embodiment, the apparatus performs the operation in conformance with the value of the setting based, at least in part, on receipt of a third touch input. For example, the apparatus may perform an image capture operation in conformance with the value of the setting based, at least in part, on receipt of a touch input indicative of selection of interface item 642 of FIG. 6D. In such an example, the apparatus may cause adjustment of the value of the setting prior to the third touch input.

In at least one example embodiment, the apparatus performs the operation in conformance with the value of the setting based, at least in part, on receipt of the release input of the first touch input. For example, the setting may relate to a sharing setting, and the value of the setting may relate to at least one of a medium for sharing, such as an email account, a social media account, a particular communication channel, etc., may relate to at least one contact to share information with, such as a phonebook entry, a phone number, a distribution list, etc. In such an example, the release input of the first touch input may cause the apparatus to perform the sharing of information in conformance with the sharing setting that was adjusted by way of the first touch input and the second touch input. In such an example, the user may perform a setting designation input that designates the sharing setting, perform an adjustment input associated with selection of a value for the sharing setting (such as medium and/or recipient of the information), and invoke the sharing operation by releasing the setting designation input. In this manner, the release input of the sharing setting designation input may cause performance of the sharing operation in conformance with the value of the sharing setting.

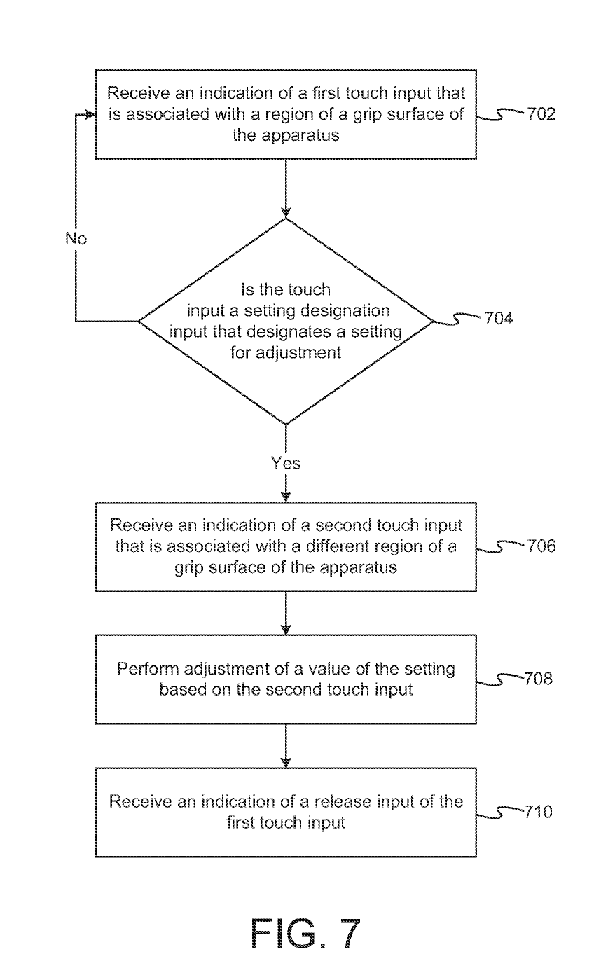

FIG. 7 is a flow diagram illustrating activities associated with adjustment of a value of a setting according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

At block 702, the apparatus receives an indication of a first touch input that is associated with a region of a grip surface of an apparatus, the first touch input comprising a contact input. The receipt, the first touch input, the region, the grip surface, and the contact input may be similar as described regarding FIGS. 2A-2D, FIGS. 3A-3E, FIGS. 4A-4D, FIGS. 5A-5C, and/or the like.

At block 704, the apparatus determines whether the first touch input is a setting designation input that designates a setting for adjustment. If the apparatus determines that the first touch input is a setting designation input that designates a setting for adjustment, flow proceeds to block 706. If the apparatus determines that the first touch input differs from a setting designation input that designates a setting for adjustment, flow returns to block 702. The determination and the setting designation input may be similar as described regarding FIGS. 3A-3E, FIGS. 6A-6D, and/or the like. In at least one example embodiment, determination that the first touch input is a setting designation input is predicated by the first touch input being associated with the region of the grip surface. In at least one example embodiment, the apparatus further performs a determination that the first touch input is associated with the region of the grip surface. In such an example, determination that the first touch input is a setting designation input may be predicated by the first touch input being associated with the region of the grip surface. In at least one example embodiment, the determination that the first touch input is a setting designation input that designates a setting for adjustment is based, at least in part, on a determination that the contact input of the first touch input exceeds a threshold force. For example, the apparatus may receive force sensor information associated with the first touch input. In such an example, the determination that the contact input of the first touch input exceeds a threshold force may be based, at least in part, on force sensor information.

At block 706, the apparatus receives an indication of a second touch input that is associated with a different region of a grip surface of the apparatus. The second touch input may be separate from the first touch input. The second touch input, the different region, and the grip surface may be similar as described regarding FIGS. 2A-2D, FIGS. 3A-3E, FIGS. 4A-4D, FIGS. 5A-5C, and/or the like.

At block 708, the apparatus performs adjustment of a value of the setting based, at least in part, on the second touch input. The adjustment and the value may be similar as described regarding FIGS. 6A-6D, FIG. 9, FIG. 10, FIG. 11, FIG. 12, and/or the like.

At block 710, the apparatus receives an indication of a release input of the first touch input. The receipt and the release input may be similar as described regarding FIGS. 2A-2E, FIGS. 6A-6D, and/or the like.

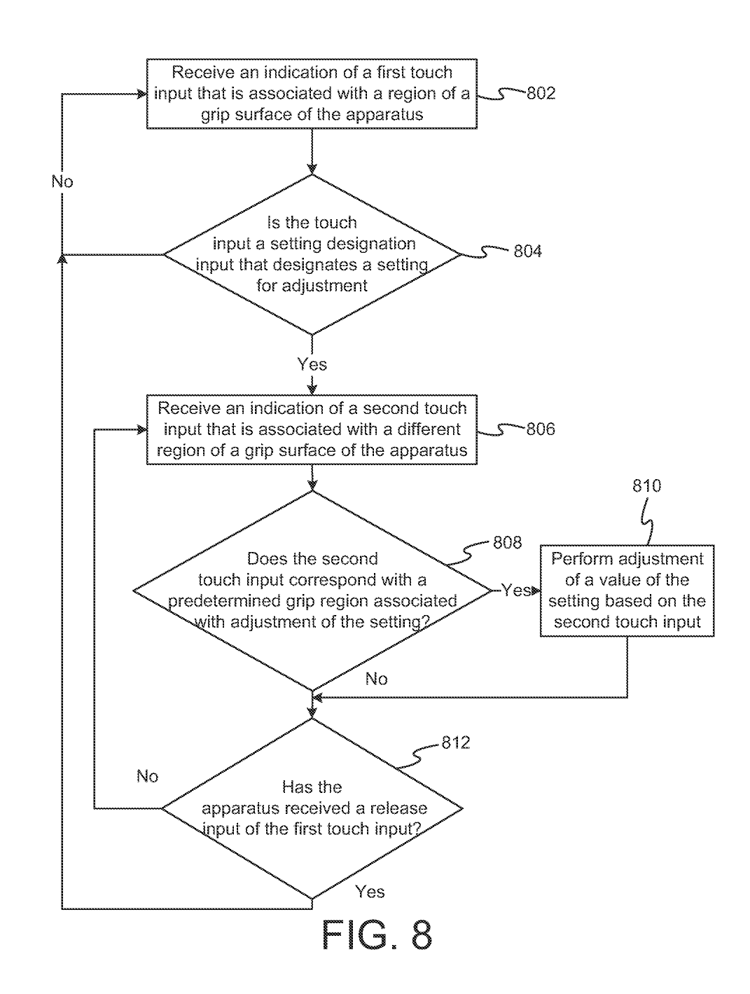

FIG. 8 is a flow diagram illustrating activities associated with adjustment of a value of a setting according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

At block 802, the apparatus receives an indication of a first touch input that is associated with a region of a grip surface of an apparatus, the first touch input comprising a contact input, similarly as described regarding block 702 of FIG. 7.

At block 804, the apparatus determines whether the first touch input is a setting designation input that designates a setting for adjustment, similarly as described regarding block 704 of FIG. 7. If the apparatus determines that the first touch input is a setting designation input that designates a setting for adjustment, flow proceeds to block 806. If the apparatus determines that the first touch input differs from a setting designation input that designates a setting for adjustment, flow returns to block 802.

At block 806, the apparatus receives an indication of a second touch input that is associated with a different region of a grip surface of the apparatus, similarly as described regarding block 706 of FIG. 6.

At block 808, the apparatus determines whether the second touch input corresponds with at least one predetermined grip region associated with adjustment of the setting. If the apparatus determines that the second touch input corresponds with at least one predetermined grip region associated with adjustment of the setting, flow proceeds to block 810. If the apparatus determines that the second touch input fails to correspond with at least one predetermined grip region associated with adjustment of the setting, flow proceeds to block 812. The predetermined grip region may be similar as described regarding FIGS. 6A-6B, and/or the like. In at least one example embodiment, determination that the second touch input corresponds with at least one predetermined grip region associated with adjustment of the setting comprises determination that the different region of the grip surface corresponds with at least one predetermined grip region associated with adjustment of the setting, similar as described regarding FIGS. 6A-6D.

At block 810, the apparatus performs adjustment of a value of the setting based, at least in part, on the second touch input, similarly as described regarding block 708 of FIG. 7. In this manner performance of adjustment of the value of the setting may be predicated by the determination that the second touch input corresponds with at least one predetermined grip region associated with adjustment of the setting.

At block 812, the apparatus determines whether a release input of the first touch input has been received. If the apparatus has received the release input of the first touch input, flow returns to block 802. If the apparatus has failed to receive a release input of the first touch input, flow proceeds to block 806. The receipt and the release input may be similar as described regarding FIGS. 2A-2E, FIGS. 6A-6D, and/or the like. In this manner, the apparatus may continue to allow for adjustment of the setting until the apparatus receives the release input of the first touch input.

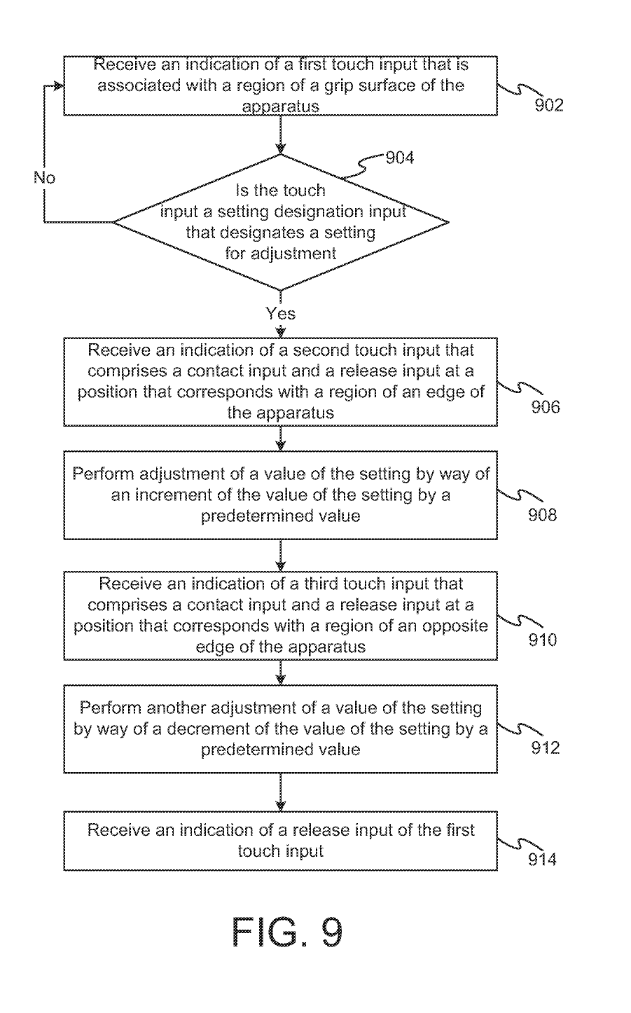

FIG. 9 is a flow diagram illustrating activities associated with adjustment of a value of a setting according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

In some circumstances, it may be desirable for the type of input that the user performs for adjustment of the value of the setting to impact the manner in which the value of the setting is adjusted. For example, it may be desirable for the user to perform a tap input to adjust the value of the setting. In such an example, the region of the grip surface in which the user performs the tap input may identify an increment adjustment of the value of the setting, a decrement adjustment of the value of the setting, magnitude of the adjustment of the value of the setting, and/or the like. For example, it may be desirable for the user to perform a touch input at a region of an edge of the apparatus to invoke an increment adjustment of the value the setting, and for the user to perform a touch input at a region of an opposite edge of the apparatus to invoke a decrement adjustment of the value of the setting. In this manner, it may be intuitive to the user that opposite edges of the apparatus may be utilized for increment and decrement adjustment designation.

In at least one example embodiment, during a setting designation input, the apparatus may receive an indication of a tap input. The apparatus may perform an adjustment of the value of the setting designated by the setting designation input by way of a decrement of the value of the setting by a predetermined value, by way of an increment of the value of the setting by a predetermined value, and/or the like. The predetermined value of the increment and/or the decrement may be unitary, may be based on position of the tap input, may be based on a stored adjustment value, and/or the like. In at least one example embodiment, determination to perform an increment is based, at least in part, on the region of the grip surface of the tap input being associated with an increment adjustment. For example, a region of the top edge of the apparatus may relate to an increment adjustment. In another example, a region of the right edge of the apparatus may relate to an increment adjustment. Similarly, in at least one example embodiment, determination to perform the decrement is based, at least in part, on the region of the grip surface of the tap input being associated with a decrement adjustment. For example, a region of the bottom edge of the apparatus may relate to a decrement adjustment. In another example, a region of the left edge of the apparatus may relate to a decrement adjustment. In this manner, the user may readily understand which grip surface upon which to perform the input based on alignment of the increment and/or decrement with geometric conventions of numeric increase being upward and/or rightward, and numeric decrease being downward and/or leftward. In this manner, polarity of the adjustment may be based, at least in part, on position of the touch input associated with adjustment of the value of the setting.

At block 902, the apparatus receives an indication of a first touch input that is associated with a region of a grip surface of an apparatus, the first touch input comprising a contact input, similarly as described regarding block 702 of FIG. 7.

At block 904, the apparatus determines whether the first touch input is a setting designation input that designates a setting for adjustment, similarly as described regarding block 704 of FIG. 7. If the apparatus determines that the first touch input is a setting designation input that designates a setting for adjustment, flow proceeds to block 906. If the apparatus determines that the first touch input differs from a setting designation input that designates a setting for adjustment, flow returns to block 902.

At block 906, the apparatus receives an indication of a second touch input that comprises a contact input and a release input at a position that corresponds with a region of an edge of the apparatus. The second touch input, the contact input, the release input, the region, and the edge may be similar as described regarding FIGS. 2A-2D, FIGS. 3A-3E, FIGS. 4A-4D, FIGS. 5A-5C, and/or the like.

At block 908, the apparatus performs adjustment of the value of the setting by way of an increment of the value of the setting by a predetermined value. The increment may be based, at least in part, on the second touch input.

At block 910, the apparatus receives an indication of a third touch input that comprises a contact input and a release input at a position that corresponds with a region of an opposite edge of the apparatus from the edge of the apparatus of the second touch input. The third touch input, the contact input, the release input, the region, and the opposite edge may be similar as described regarding FIGS. 2A-2D, FIGS. 3A-3E, FIGS. 4A-4D, FIGS. 5A-5C, and/or the like.

At block 912, the apparatus performs another adjustment of the value of the setting by way of a decrement of the value of the setting by the predetermined value. The decrement may be based, at least in part, on the third touch input.

At block 914, the apparatus receives an indication of a release input of the first touch input, similarly as described regarding block 710 of FIG. 7.

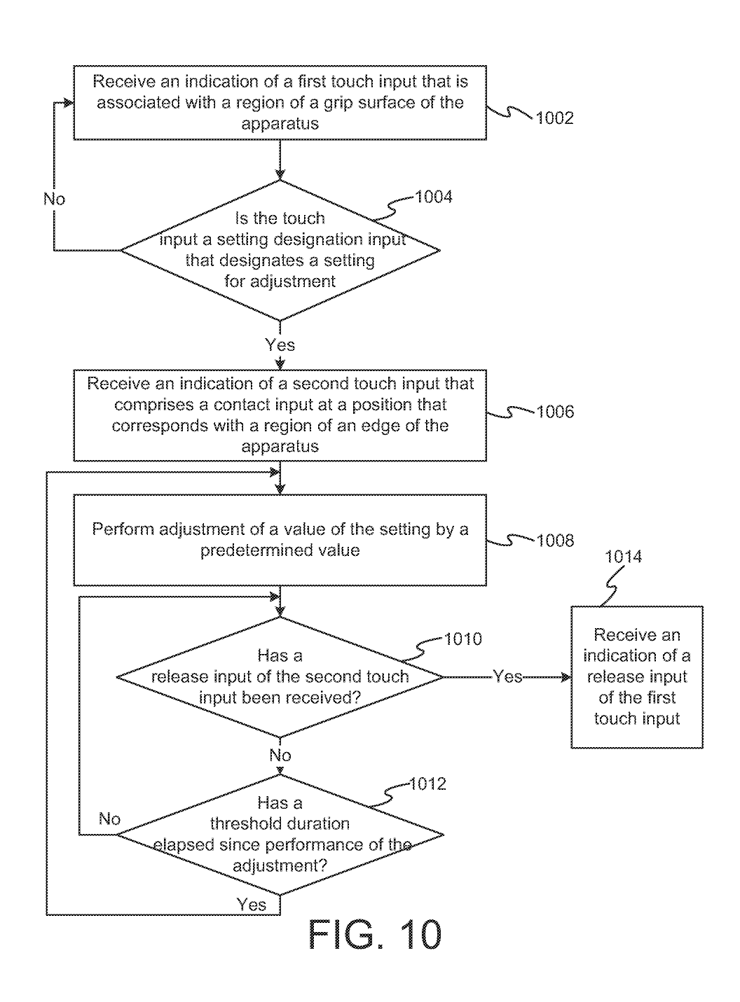

FIG. 10 is a flow diagram illustrating activities associated with adjustment of a value of a setting according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

In some circumstances, the user may desire to repeatedly adjust the value of the setting without performing multiple tap inputs. For example, the user may desire to increment or decrement the value of the setting multiple times without performing multiple tap inputs. In such circumstances, it may be desirable to allow the user to increase the duration between the contact input and release input of the touch input of the adjustment of the value of the setting to cause the apparatus to perform multiple increments and/or decrements of the value of the setting. In this manner, the user may be able to control the amount of increment adjustments or decrement adjustments that are performed by the apparatus by varying the duration of the touch input.

In at least one example embodiment, during a setting designation input, the apparatus may receive an indication of a contact input for adjustment. The apparatus may determine to perform an increment adjustment and/or a decrement adjustment of the value of the setting based, at least in part, on the contact input. In at least one example embodiment, the apparatus determines that a threshold duration has elapsed since performance of the adjustment absent receipt of the release input of the touch input for adjustment. The threshold duration may relate to a predetermined amount of time between consecutive increment and/or decrement adjustments. For example, the threshold duration may be 500 milliseconds, such that the apparatus will perform an increment and/or decrement adjustment for each 500 millisecond period between the contact input and the release input of the touch input.

In some circumstances, it may be desirable of the user to terminate adjustment of the value of the setting by releasing the setting designation input. In this manner, the apparatus may determine that a threshold duration has elapsed since performance of the adjustment absent receipt of the release input of the touch input for adjustment and the release input of the setting designation input.

At block 1002, the apparatus receives an indication of a first touch input that is associated with a region of a grip surface of an apparatus, the first touch input comprising a contact input, similarly as described regarding block 702 of FIG. 7.

At block 1004, the apparatus determines whether the first touch input is a setting designation input that designates a setting for adjustment, similarly as described regarding block 704 of FIG. 7. If the apparatus determines that the first touch input is a setting designation input that designates a setting for adjustment, flow proceeds to block 1006. If the apparatus determines that the first touch input differs from a setting designation input that designates a setting for adjustment, flow returns to block 1002.

At block 1006, the apparatus receives an indication of a second touch input that comprises a contact input at a position that corresponds with a region of an edge of the apparatus. The second touch input, the contact input, the region, and the edge may be similar as described regarding FIGS. 2A-2D, FIGS. 3A-3E, FIGS. 4A-4D, FIGS. 5A-5C, and/or the like.

At block 1008, the apparatus performs adjustment of the value of the setting by a predetermined value. The adjustment may be based, at least in part, on the second touch input. The adjustment may be by way of an increment, a decrement, and/or the like.

At block 1010, the apparatus determines whether a release input of the second touch input has been received. The receipt and the release input may be similar as described regarding FIGS. 3A-3E, and/or the like. If the apparatus determines that the release input of the second touch input has been received, flow proceeds to block 1014. If the apparatus determines that the release input of the second touch input has not been received, flow proceeds to block 1012.

At block 1012, the apparatus determines whether a threshold duration has elapsed since performance of the adjustment of the value of the setting. If the apparatus determines that the threshold duration has not elapsed since performance of the adjustment of the value of the setting, flow returns to block 1010. If the apparatus determines that the threshold duration has elapsed since performance of the adjustment of the value of the setting, flow returns to block 1008. In this manner, the apparatus performs another adjustment of the value of the setting by the predetermined value based, at least in part, on the determination that the threshold duration has elapsed since performance of the adjustment absent receipt of the release input of the second touch input. In this manner, the other adjustment may be caused by the elapse of the threshold duration.

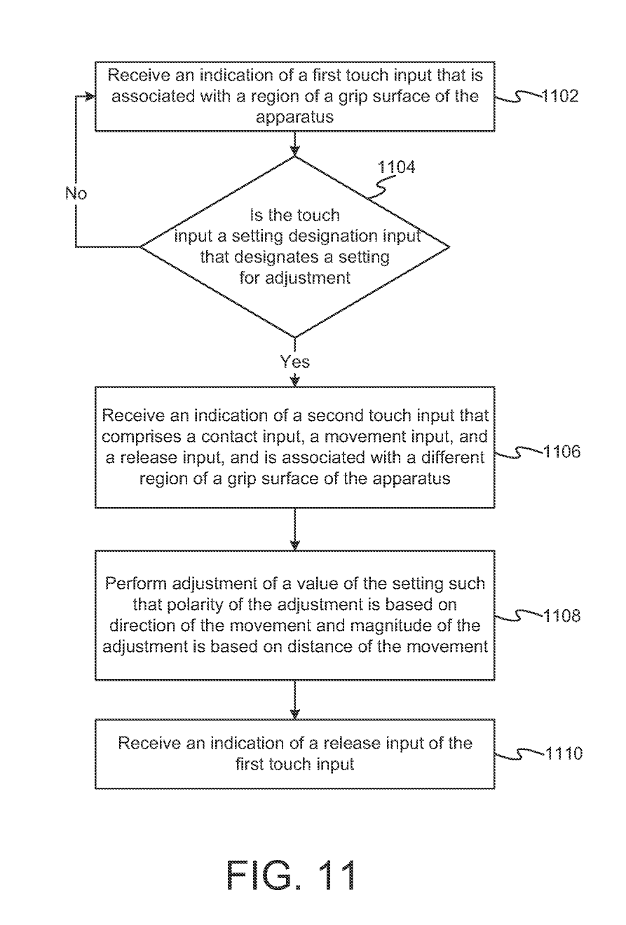

FIG. 11 is a flow diagram illustrating activities associated with adjustment of a value of a setting according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

In some circumstances, it may be desirable for the user to adjust the value of the setting by way of movement of the adjustment input. For example, the user may desire to utilize a drag input such that the distance of the drag input corresponds with the adjustment of the value of the setting.

In at least one example embodiment, during a setting designation input, the apparatus may receive an indication of a touch input for adjustment. The touch input for adjustment may comprise a contact input, a movement input, and a release input. In at least one example embodiment, the apparatus may perform adjustment of the value of the setting indicated by the setting designation input based, at least in part, on the movement input. In at least one example embodiment, polarity of the adjustment of the value of the setting is based, at least in part, on the direction of the movement input. For example, the apparatus may perform the adjustment by way of either an increase of the value of the setting, or a decrease in the value of the setting based, at least in part on a direction of the movement input. In at least one example embodiment, a magnitude of the adjustment of the value of the setting is based, at least in part, on a distance of the movement input. For example, a shorter distance may be associated with a lesser adjustment of the value of the setting than that of a longer distance.

At block 1102, the apparatus receives an indication of a first touch input that is associated with a region of a grip surface of an apparatus, the first touch input comprising a contact input, similarly as described regarding block 702 of FIG. 7.

At block 1104, the apparatus determines whether the first touch input is a setting designation input that designates a setting for adjustment, similarly as described regarding block 704 of FIG. 7. If the apparatus determines that the first touch input is a setting designation input that designates a setting for adjustment, flow proceeds to block 1106. If the apparatus determines that the first touch input differs from a setting designation input that designates a setting for adjustment, flow returns to block 1102.

At block 1106, the apparatus receives an indication of a second touch input that is associated with a different region of a grip surface of the apparatus. The second touch input of block 1106 comprises a contact input, a movement input, and a release input. For example, the second touch input may be a drag input. The second touch input may be separate from the first touch input. The second touch input, the contact input, the movement input, the release input, the different region, and the grip surface may be similar as described regarding FIGS. 2A-2D, FIGS. 3A-3E, FIGS. 4A-4D, FIGS. 5A-5C, and/or the like.

At block 1108, the apparatus performs adjustment of the value of the setting by way of either of an increase of the value of the setting, or a decrease in the value of the setting based, at least in part on a direction of the movement input, such that a magnitude of the adjustment of the value of the setting is based, at least in part, on a distance of the movement input. In some circumstances, performance of the adjustment may be based, at least in part, on a determination that the second touch input is a drag input. For example, performance of the adjustment may be predicated by determination that the second touch input is a drag input.

At block 1110, the apparatus receives an indication of a release input of the first touch input, similarly as described regarding block 710 of FIG. 7.

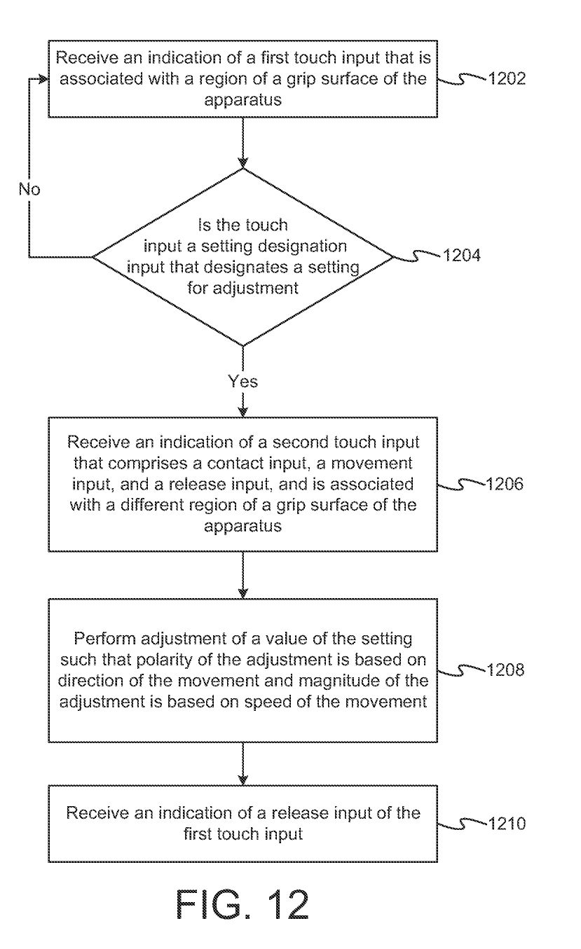

FIG. 12 is a flow diagram illustrating activities associated with adjustment of a value of a setting according to at least one example embodiment. In at least one example embodiment, there is a set of operations that corresponds with the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12.

In some circumstances, it may be desirable for the user to adjust the value of the setting by way of movement of the adjustment input. For example, the user may desire to utilize a flick input such that the speed of the flick input corresponds with the adjustment of the value of the setting.

In at least one example embodiment, during a setting designation input, the apparatus may receive an indication of a touch input for adjustment. The touch input for adjustment may comprise a contact input, a movement input, and a release input. In at least one example embodiment, the apparatus may perform adjustment of the value of the setting indicated by the setting designation input based, at least in part, on the movement input. In at least one example embodiment, polarity of the adjustment of the value of the setting is based, at least in part, on the direction of the movement input. For example, the apparatus may perform the adjustment by way of either an increase of the value of the setting, or a decrease in the value of the setting based, at least in part on a direction of the movement input. In at least one example embodiment, a magnitude of the adjustment of the value of the setting is based, at least in part, on a speed of the movement input. For example, a slower speed may be associated with a lesser adjustment of the value of the setting than that of a faster speed.

At block 1202, the apparatus receives an indication of a first touch input that is associated with a region of a grip surface of an apparatus, the first touch input comprising a contact input, similarly as described regarding block 702 of FIG. 7.

At block 1204, the apparatus determines whether the first touch input is a setting designation input that designates a setting for adjustment, similarly as described regarding block 704 of FIG. 7. If the apparatus determines that the first touch input is a setting designation input that designates a setting for adjustment, flow proceeds to block 1206. If the apparatus determines that the first touch input differs from a setting designation input that designates a setting for adjustment, flow returns to block 1202.

At block 1206, the apparatus receives an indication of a second touch input that is associated with a different region of a grip surface of the apparatus. The second touch input of block 1106 comprises a contact input, a movement input, and a release input. For example, the second touch input may be a drag input. The second touch input may be separate from the first touch input. The second touch input, the contact input, the movement input, the release input, the different region, and the grip surface may be similar as described regarding FIGS. 2A-2D, FIGS. 3A-3E, FIGS. 4A-4D, FIGS. 5A-5C, and/or the like.

At block 1208, the apparatus performs adjustment of the value of the setting by way of either of an increase of the value of the setting, or a decrease in the value of the setting based, at least in part on a direction of the movement input, such that a magnitude of the adjustment of the value of the setting is based, at least in part, on a speed of the movement input. In some circumstances, performance of the adjustment may be based, at least in part, on a determination that the second touch input is a flick input. For example, performance of the adjustment may be predicated by determination that the second touch input is a flick input.

At block 1210, the apparatus receives an indication of a release input of the first touch input, similarly as described regarding block 710 of FIG. 7.

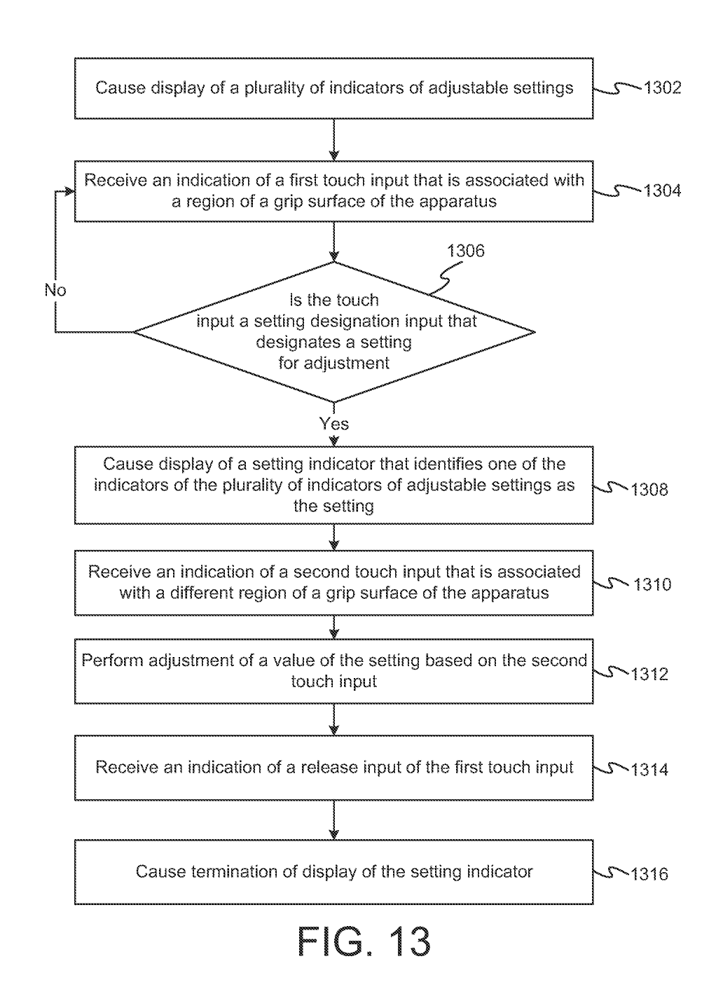

FIG. 13 is a flow diagram illustrating activities associated with adjustment of a value of a setting according to at least one example embodiment. In at least one example embodiment, there is a set of operations that corresponds with the activities of FIG. 13. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 13.

At block 1302, the apparatus causes display of a plurality of indicators of adjustable settings. The causation of display and the plurality of indicators of adjustable settings may be similar as described regarding FIGS. 6A-6D, and/or the like.

At block 1304, the apparatus receives an indication of a first touch input that is associated with a region of a grip surface of an apparatus, the first touch input comprising a contact input, similarly as described regarding block 702 of FIG. 7.

At block 1306, the apparatus determines whether the first touch input is a setting designation input that designates a setting for adjustment, similarly as described regarding block 704 of FIG. 7. If the apparatus determines that the first touch input is a setting designation input that designates a setting for adjustment, flow proceeds to block 1308. If the apparatus determines that the first touch input differs from a setting designation input that designates a setting for adjustment, flow returns to block 1304.

At block 1308, the apparatus causes display of a setting indicator that identifies the setting. The causation of display and the setting indicator may be similar as described regarding FIGS. 6A-6D, and/or the like.

At block 1310, the apparatus receives an indication of a second touch input that is associated with a different region of a grip surface of the apparatus, similarly as described regarding block 706 of FIG. 7. At block 1312, the apparatus performs adjustment of a value of the setting based, at least in part, on the second touch input, similarly as described regarding block 708 of FIG. 7. At block 1314, the apparatus receives an indication of a release input of the first touch input, similarly as described regarding block 710 of FIG. 7.

At block 1316, the apparatus causes of termination of display of the setting indicator based, at least in part, on receipt of the release input of the first touch input. The termination of display may be similar as described regarding FIGS. 6A-6D, and/or the like. In this manner termination of display of the setting indicator may be based, at least in part, on receipt of the release input of the first touch input. For example, termination of display of the setting indicator may be caused by receipt of the release input of the first touch input.

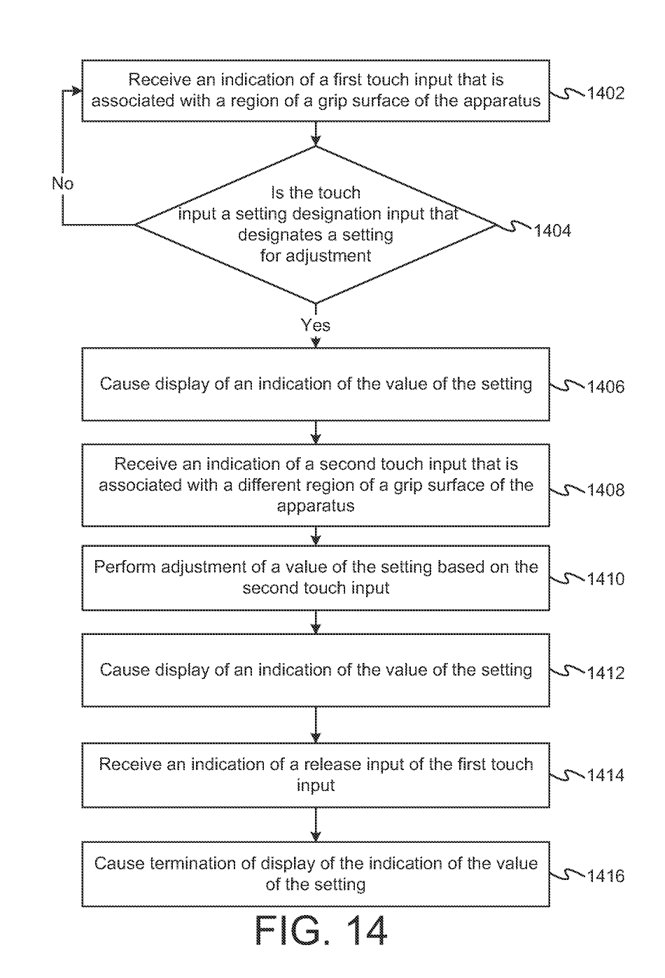

FIG. 14 is a flow diagram illustrating activities associated with adjustment of a value of a setting according to at least one example embodiment. In at least one example embodiment, there is a set of operations that corresponds with the activities of FIG. 14. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 14.

At block 1402, the apparatus receives an indication of a first touch input that is associated with a region of a grip surface of an apparatus, the first touch input comprising a contact input, similarly as described regarding block 702 of FIG. 7.

At block 1404, the apparatus determines whether the first touch input is a setting designation input that designates a setting for adjustment, similarly as described regarding block 704 of FIG. 7. If the apparatus determines that the first touch input is a setting designation input that designates a setting for adjustment, flow proceeds to block 1406. If the apparatus determines that the first touch input differs from a setting designation input that designates a setting for adjustment, flow returns to block 1402.

At block 1406, the apparatus causes display of an indication of the value of the setting. The causation of display and the value of the setting may be similar as described regarding FIGS. 6A-6D.

At block 1408, the apparatus receives an indication of a second touch input that is associated with a different region of a grip surface of the apparatus, similarly as described regarding block 706 of FIG. 6. At block 1410, the apparatus performs adjustment of a value of the setting based, at least in part, on the second touch input, similarly as described regarding block 708 of FIG. 7.

At block 1412, the apparatus causes display of an indication of the value of the setting, similarly as described regarding block 1406. In this manner, the apparatus may cause display of the adjusted value of the setting.

At block 1414, the apparatus receives an indication of a release input of the first touch input, similarly as described regarding block 710 of FIG. 7.

At block 1416, the apparatus causes termination of display of the indication of the value of the setting. The termination of display may be similar as described regarding FIGS. 6A-6D, and/or the like. In this manner termination of display of the setting indicator may be based, at least in part, on receipt of the release input of the first touch input. For example, termination of display of the setting indicator may be caused by receipt of the release input of the first touch input.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 708 of FIG. 7 may be performed after block 710. Furthermore, if desired, one or more of the above-described functions may be optional or may be combined. For example, blocks 1412 of FIG. 14 may be optional and/or combined with block 1410.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
receive an indication of a first touch input that is associated with a region of a grip surface of an apparatus, the first touch input comprising a contact input;
determine that the first touch input is a setting designation input that designates a setting for adjustment;
receive an indication of a second touch input that is associated with a different region of a grip surface of the apparatus, the second touch input being separate from the first touch input;
perform adjustment of a value of the setting based, at least in part, on the second touch input; and
receive an indication of a release input of the first touch input.

2. The apparatus of claim 1, wherein the memory includes computer program code configured to, working with the processor, cause the apparatus to perform determination that the second touch input corresponds with at least one predetermined grip region associated with adjustment of the setting, wherein performance of adjustment of the value of the setting is predicated by the determination that the second touch input corresponds with at least one predetermined grip region associated with adjustment of the setting.

3. The apparatus of claim 1, wherein the second touch input comprises a contact input and a release input at a position that corresponds with a region of an edge of the apparatus, and performance of the adjustment of the value of the setting is by way of an increment of the value of the setting by a predetermined value.

4. The apparatus of claim 3, wherein the memory includes computer program code configured to, working with the processor, cause the apparatus to perform:
determination that a threshold duration has elapsed since performance of the adjustment absent receipt of the release input of the second touch input; and
performance of another adjustment of the value of the setting by way of an increment of the value of the setting by the predetermined value based, at least in part, on the determination that the threshold duration has elapsed since performance of the adjustment absent receipt of the release input of the second touch input.

5. The apparatus of claim 3, wherein the memory includes computer program code configured to, working with the processor, cause the apparatus to perform:
receipt of an indication of a third touch input that comprises a contact input and a release input at a position that corresponds with a region of an opposite edge of the apparatus from the edge of the apparatus of the second touch input; and
performance of another adjustment of the value of the setting by way of a decrement of the value of the setting by the predetermined value.

6. The apparatus of claim 5, wherein the memory includes computer program code configured to, working with the processor, cause the apparatus to perform:
determination that a threshold duration has elapsed since performance of the other adjustment absent receipt of the release input of the third touch input; and
performance of another different adjustment of the value of the setting by way of another decrement of the value of the setting by the predetermined value based, at least in part, on the determination that the threshold duration has elapsed since performance of the other adjustment absent receipt of the release input of the third touch input.

7. The apparatus of claim 1, wherein the second touch input comprises a contact input, a movement input, and a release input, wherein the performance of the adjustment of the value of the setting by way of either of an increase of the value of the setting, or a decrease in the value of the setting based, at least in part on a direction of the movement input.

8. The apparatus of claim 7, wherein a magnitude of the adjustment of the value of the setting is based, at least in part, on a distance of the movement input.

9. The apparatus of claim 7, wherein a magnitude of the adjustment of the value of the setting is based, at least in part, on a speed of the movement input.

10. A method comprising:
receiving an indication of a first touch input that is associated with a region of a grip surface of an apparatus, the first touch input comprising a contact input;
determining that the first touch input is a setting designation input that designates a setting for adjustment;
receiving an indication of a second touch input that is associated with a different region of a grip surface of the apparatus, the second touch input being separate from the first touch input;
performing adjustment of a value of the setting based, at least in part, on the second touch input; and
receiving an indication of a release input of the first touch input.

11. The method of claim 10, further comprising determination that the second touch input corresponds with at least one predetermined grip region associated with adjustment of the setting, wherein performance of adjustment of the value of the setting is predicated by the determination that the second touch input corresponds with at least one predetermined grip region associated with adjustment of the setting.

12. The method of claim 10, wherein the second touch input comprises a contact input and a release input at a position that corresponds with a region of an edge of the apparatus, and performance of the adjustment of the value of the setting is by way of an increment of the value of the setting by a predetermined value.

13. The method of claim 12, further comprising:
determination that a threshold duration has elapsed since performance of the adjustment absent receipt of the release input of the second touch input; and
performance of another adjustment of the value of the setting by way of an increment of the value of the setting by the predetermined value based, at least in part, on the determination that the threshold duration has elapsed since performance of the adjustment absent receipt of the release input of the second touch input.

14. The method of claim 12, further comprising:
receipt of an indication of a third touch input that comprises a contact input and a release input at a position that corresponds with a region of an opposite edge of the apparatus from the edge of the apparatus of the second touch input; and
performance of another adjustment of the value of the setting by way of a decrement of the value of the setting by the predetermined value.

15. The method of claim 14, further comprising:
determination that a threshold duration has elapsed since performance of the other adjustment absent receipt of the release input of the third touch input; and
performance of another different adjustment of the value of the setting by way of another decrement of the value of the setting by the predetermined value based, at least in part, on the determination that the threshold duration has elapsed since performance of the other adjustment absent receipt of the release input of the third touch input.

16. The method of claim 10, wherein the second touch input comprises a contact input, a movement input, and a release input, wherein the performance of the adjustment of the value of the setting by way of either of an increase of the value of the setting, or a decrease in the value of the setting based, at least in part on a direction of the movement input.

17. At least one computer-readable medium encoded with instructions that, when executed by a processor, perform:
receive an indication of a first touch input that is associated with a region of a grip surface of an apparatus, the first touch input comprising a contact input;
determine that the first touch input is a setting designation input that designates a setting for adjustment;
receive an indication of a second touch input that is associated with a different region of a grip surface of the apparatus, the second touch input being separate from the first touch input;
perform adjustment of a value of the setting based, at least in part, on the second touch input; and
receive an indication of a release input of the first touch input.

18. The medium of claim 17, further encoded with instructions that, when executed by a processor, perform determination that the second touch input corresponds with at least one predetermined grip region associated with adjustment of the setting, wherein performance of adjustment of the value of the setting is predicated by the determination that the second touch input corresponds with at least one predetermined grip region associated with adjustment of the setting.

19. The medium of claim 17, wherein the second touch input comprises a contact input and a release input at a position that corresponds with a region of an edge of the apparatus, and performance of the adjustment of the value of the setting is by way of an increment of the value of the setting by a predetermined value.

20. The medium of claim 19, further encoded with instructions that, when executed by a processor, perform:
determination that a threshold duration has elapsed since performance of the adjustment absent receipt of the release input of the second touch input; and
performance of another adjustment of the value of the setting by way of an increment of the value of the setting by the predetermined value based, at least in part, on the determination that the threshold duration has elapsed since performance of the adjustment absent receipt of the release input of the second touch input.
